(19) United States
(12) Patent Application Publication
(10) Pub. No.: US 2010/0196750 A1
(43) Pub. Date: Aug. 5, 2010

(54) SEPARATOR AND BATTERY

(75) Inventors: Atsushi Kajita, Fukushima (JP); Yukako Teshima, Fukuoka (JP); Kazuki Chiba, Fukushima (JP); Takuya Endo, Fukushima (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/697,458

(22) Filed: Feb. 1, 2010

(30) Foreign Application Priority Data
Feb. 3, 2009 (JP) P2009-023110
Nov. 30, 2009 (JP) P2009-272991

(51) Int. Cl. H01M 2/16

(52) U.S. Cl. 429/145

(57) ABSTRACT

A separator including a first layer having a first principal surface and a second principal surface and a second layer disposed on at least one of the first principal surface and the second principal surface, wherein the first layer is a microporous film containing a polymer resin, the second layer is a microporous film containing particles having an electrically insulating property and fibrils having an average diameter of 1 μm or less, and the fibrils have a three-dimensional network structure in which the fibrils are mutually linked.

### CROSS REFERENCES TO RELATED APPLICATIONS

The present application claims priority to Japanese Priority Patent Application JP 2009-023110 filed in the Japan Patent Office on Feb. 3, 2009 and JP 2009-272991 filed in the Japan Patent Office on Nov. 30, 2009, the entire contents of which are hereby incorporated by reference.

### BACKGROUND

The present application relates to a separator and a battery including the separator. In particular, the present application relates to a lamination type separator.

In recent years, portable electronics have been developed significantly and, therefore, electronic apparatuses, e.g., cellular phones and notebook computers, are recognized as fundamental technologies to support a highly information-oriented society. Furthermore, research and development on an achievement of greater functionality of these electronic apparatuses have been conducted intensively, and power consumption of these electronic apparatuses have steadily increased proportionately. On the other hand, it is desired that these electronic apparatuses are driven for a long time, and an increase in energy density of a secondary battery, which is a drive power supply, is desired as a natural next step. Moreover, it is desired that the energy density of the battery is higher from the viewpoint of taking up of the volume and the mass of a battery incorporated in an electronic apparatus. Consequently, at present, lithium ion secondary batteries having excellent energy density are incorporated in almost all apparatuses.

Various safety circuits are mounted on the lithium ion secondary batteries and in the configuration, even when short-circuit occurs in the inside of a battery, a current is stopped and the safety can be ensured. As described above, the battery is designed in such a way that sufficient safety can be ensured under the usual working condition. However, a higher level of safety has been desired in order to meet an increase in capacity of recent years.

For example, internal short-circuit may occur due to inclusion of a substance having electrical conductivity (hereafter may be referred to as contamination) or an occurrence of dendride. In such a case, if the safety circuit does not function, a large current may pass in the inside of the battery, Joule's heat may be generated, and abnormal heat generation may occur. In the past, the resistance of a polyolefin separator against contamination and dendride depends on the mechanical properties of the separator, and an occurrence of a phenomenon, in which the separator is fractured, may cause abnormal heat generation. In order to realize higher safety, suppression of such abnormal heat generation is desired.

In order to realize such an improvement in the safety, for example, Japanese Patent No. 3797729 proposes that after a surface of a polyolefin separator is subjected to a treatment to become easy-to-adhere, an inorganic layer is formed on the separator surface, so as to improve the mechanical strength of the separator. However, in recent years, a separator further excellent in suppression of heat generation and exhibiting a higher level of safety as compared with the separator proposed in the past has been desired.

### SUMMARY

Accordingly, it is desirable to provide a separator, wherein even when a phenomenon, in which the separator is fractured due to contamination or dendride, heat generation can be suppressed and a battery including the separator.

A separator according to an embodiment includes a first layer having a first principal surface and a second principal surface, and a second layer disposed on at least one of the first principal surface and the second principal surface, wherein the first layer is a microporous film containing a polymer resin, the second layer is a microporous film containing particles having an electrically insulating property and fibrils having an average diameter of 1 μm or less, and the fibrils have a three-dimensional network structure in which the fibrils are mutually linked.

A separator according to an embodiment is a separator, wherein when sandwiched between copper foil and aluminum foil with a letter L shaped nickel piece of 0.2 mm high×0.1 mm wide with each side of 1 mm disposed between the copper foil or the aluminum foil, a voltage of 12 V in a constant-current condition of 25 A is applied between the copper foil and the aluminum foil, and the nickel piece is pressurized with 98 N, a short-circuit resistance of 1Ω or more is obtained.

A battery according to an embodiment includes a positive electrode, a negative electrode, an electrolyte, and a separator, wherein the separator includes a first layer having a first principal surface and a second principal surface, and a second layer disposed on at least one of the first principal surface and the second principal surface, the first layer is a microporous film containing a polymer resin, the second layer is a microporous film containing particles having an electrically insulating property and fibrils having an average diameter of 1 μm or less, and the fibrils have a three-dimensional network structure in which the fibrils are mutually linked.

A battery according to an embodiment includes a positive electrode, a negative electrode, an electrolyte, and a separator, wherein regarding the separator, when sandwiched between copper foil and aluminum foil with a letter L shaped nickel piece of 0.2 mm high×0.1 mm wide with each side of 1 mm disposed between the copper foil or the aluminum foil, a voltage of 12 V in a constant-current condition of 25 A is applied between the copper foil and the aluminum foil, and the nickel piece is pressurized with 98 N, a short-circuit resistance of 1Ω or more is obtained.

In the present application, the nickel piece is a nickel piece specified in the item JIS C8714 5.5.2.

In the present application, in the case where an inclusion is present between the electrode and the separator and the separator is fractured due to this inclusion, the second layer is transferred to the inclusion, so that the second layer is interposed between the electrode and the inclusion. Here, the transfer refers to that the second layer covers a contact surface, which has been in contact with the separator immediately before the fracture, in the surface of the inclusion. A part of the above-described contact surface may be covered. However, it is preferable that the above-described contact surface is wholly covered from the viewpoint of suppression of heat generation. Therefore, in the case where contamination or dendride occurs in the inside of the battery, an occurrence of short-circuit can be suppressed. Alternatively, even in the case where short-circuit occurs, a short-circuit area can be reduced. Consequently, generation of a large current can be suppressed.

As described above, according to an embodiment, an occurrence of heat generation can be suppressed even when a phenomenon, in which the separator is fractured due to contamination or dendride, occurs. Consequently, the safety of the battery can be improved.

Additional features and advantages are described herein, and will be apparent from the following Detailed Description and the figures.

### BRIEF DESCRIPTION OF THE FIGURES

FIG. 1 is a sectional view showing a configuration example of a nonaqueous electrolyte secondary battery according to a first embodiment;

FIG. 2 is a magnified sectional view of a part of the rolled electrode member shown in FIG. 1;

FIG. 3 is a sectional view showing a configuration example of a separator according to the first embodiment;

FIG. 4 is a schematic diagram showing a configuration example of a second layer of the separator according to the first embodiment;

FIG. 5 is an exploded perspective view showing a configuration example of a nonaqueous electrolyte secondary battery according to a second embodiment;

FIG. 6 is a sectional view of the section of the rolled electrode member shown in FIG. 5, taken along a line VI-VI shown in FIG. 5;

FIG. 7 is a SEM photograph showing the configuration of a second layer of a separator of Sample 1;

FIG. 8 is a SEM photograph showing the configuration of a second layer of a separator of Sample 4;

FIG. 9 is a SEM photograph showing the configuration of a second layer of a separator of Sample 6;

FIG. 10 is a perspective view for explaining a method for a short-circuit test in an example;

FIG. 11 is a perspective view for explaining a method for a short-circuit test in an example; and

FIG. 12 is a side view for explaining a method for a short-circuit test in an example.

### DETAILED DESCRIPTION

The present application will be explained with reference to the drawings in the following order.

### (1) First Embodiment

### An Example of a Circular Cylinder Type Battery

### (2) Second Embodiment

### An Example of a Flat Type Battery

### 1. First Embodiment

Configuration of battery

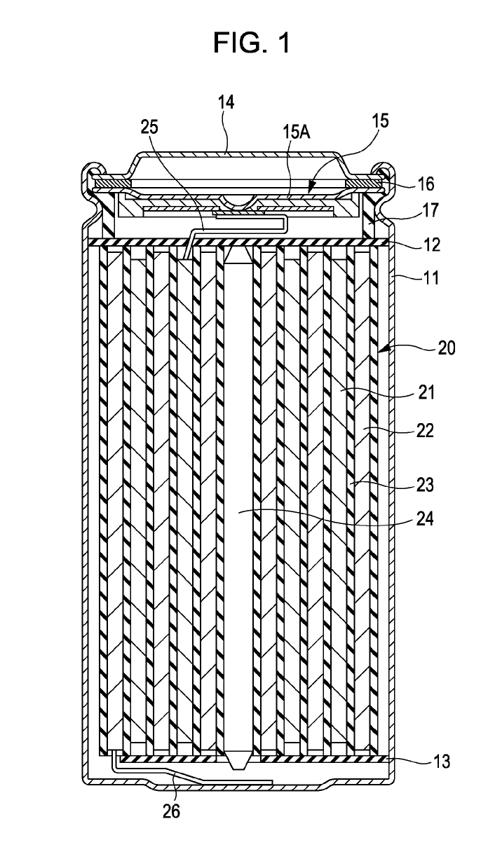

FIG. 1 is a sectional view showing a configuration example of a nonaqueous electrolyte secondary battery according to a first embodiment. This nonaqueous electrolyte secondary battery is a so-called lithium ion secondary battery, in which the capacity of the negative electrode is represented by a capacity component based on absorption and release of lithium (Li) serving as an electrode reactant. This nonaqueous electrolyte secondary battery is a so called circular cylinder type and has a rolled electrode member 20, in which a pair of a band-shaped positive electrode 21 and a band-shaped negative electrode 22 are laminated with a separator 23 therebetween and rolled, in the inside of a battery can 11 substantially in the shape of a hollow circular cylinder. The battery can 11 is formed from iron (Fe) plated with nickel (Ni), one end portion is closed, and the other end portion is opened. In the inside of the battery can 11, an electrolytic solution is injected and the separator 23 is impregnated therewith. Furthermore, each of a pair of insulating plates 12 and 13 is disposed perpendicularly to the circumferential surface of the roll in such a way as to sandwich the rolled electrode member 20 therebetween.

A battery lid 14 and a safety valve mechanism 15 and a positive temperature coefficient element (PTC element) 16, which are disposed on the inner side of this battery lid 14, are attached to the open end portion of the battery can 11 by swaging with a sealing gasket 17 therebetween. In this manner, the inside of the battery can 11 is sealed. The battery lid 14 is formed from, for example, the same material as the material for the battery can 11. The safety valve mechanism 15 is electrically connected to the battery lid 14. In the case where the internal pressure of the battery becomes a predetermined value or more because of internal short-circuit, heating from the outside, or the like, a disk plate 15A is inverted and, thereby, electrical connection between the battery lid 14 and the rolled electrode member 20 is cut. The sealing gasket 17 is formed from, for example, an insulating material and the surface is coated with asphalt.

For example, a center pin 24 is inserted into the center of the rolled electrode member 20. A positive electrode lead 25 formed from, for example, aluminum (Al) is connected to the positive electrode 21 of the rolled electrode member 20, and a negative electrode lead 26 formed from, for example, nickel is connected to the negative electrode 22. The positive electrode lead 25 is welded to the safety valve mechanism 15 and, thereby, is electrically connected to the battery lid 14. The negative electrode lead 26 is welded to the battery can 11 so as to be electrically connected.

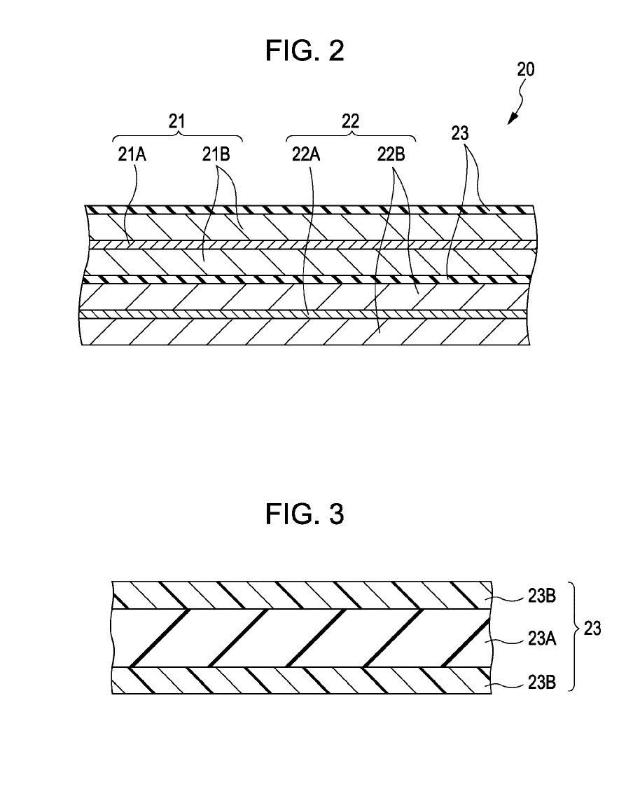

FIG. 2 is a magnified sectional view showing a part of the rolled electrode member 20 shown in FIG. 1. The positive electrode 21, the negative electrode 22, the separator 23, and the electrolytic solution constituting the secondary battery will be described below sequentially with reference to FIG. 2.

Positive Electrode

The positive electrode 21 has a structure in which, for example, positive electrode active material layers 21B are disposed on both surfaces of a positive electrode collector 21A. Although not shown in the drawing, the positive electrode active material layer 21B may be disposed on merely one surface of the positive electrode collector 21A. The positive electrode collector 21A is formed from, for example, metal foil, e.g., aluminum foil. For example, the positive electrode active material layer 21B is configured to contain at least one type of positive electrode material, which can absorb and release lithium, as the positive electrode active material and, if necessary, contain an electrically conductive agent, e.g., graphite, and a binder, e.g., polyvinylidene fluoride.

As for the positive electrode material, which can absorb and release lithium, for example, a lithium oxide, a lithium phosphorus oxide, a lithium sulfide, or a lithium-containing compound, e.g., an interlayer compound containing lithium, is suitable. At least two types thereof may be used in combination. In order to increase the energy density, a lithium-containing compound containing lithium, transition metal element, and oxygen (O) is preferable, and most of all, a compound containing at least one type selected from the group consisting of cobalt (Co), nickel (Ni), manganese (Mn), and iron (Fe) as the transition metal element is more preferable. Examples of such lithium-containing compounds include lithium composite oxides, which are represented by Formula (1), Formula (2), or Formula (3) and which have a layered rock salt type structure, lithium composite oxides, which are represented by Formula (4) and which have a spinel structure, and lithium composite phosphates, which are represented by Formula (5) and which have an olivine type structure. Specific examples include LiNi_{0.50}Co_{0.20}Mn_{0.30}O₂, LiₐCoO₂ (a≈1), Li_{b}NiO₂ (b≈1), Li_{c1}Ni_{c2}Co_{1-c2}O₂ (c1≈1, 021 c2<1), Li_{d}Mn₂O₄ (d≈1), and Li_{c}FePO₄ (e≈1).

Li_{f}Mn_{(1-g-h)}Ni_{g}M1ₕO₍₂₋ⱼ₎Fₖ (1)

(In Formula, M1 represents at least one type selected from the group consisting of cobalt (Co), magnesium (Mg), aluminum (Al), boron (B), titanium (Ti), vanadium (V), chromium (Cr), iron (Fe), copper (Cu), zinc (Zn), zirconium (Zr), molybdenum (Mo), tin (Sn), calcium (Ca), strontium (Sr), and tungsten (W), and f, g, h, j, and k are values within the range of 0.8≦f≦1.2, 0<g<0.5, 0≦h≦0.5, g+h≦1, −0.1≦j≦0.2, and 0≦k≦0.1. In this regard, the composition of lithium is different depending on the charged or discharged state and the value off indicates a value in a completely discharged state.)

LiₘNi₍₁₋ₙ₎M2ₙO₍₂₋ₚ₎F_{q} (2)

(In Formula, M2 represents at least one type selected from the group consisting of cobalt (Co), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W), and m, n, p, and q are values within the range of 0.8≦m≦1.2, 0.005≦n≦0.5, −0.1≦p≦0.2, and 0≦q≦0.1. In this regard, the composition of lithium is different depending on the charged or discharged state, and the value of m indicates a value in a completely discharged state.)

LiᵣCo₍₁₋ₛ₎M3ₛO₍₂₋ₜ₎Fᵤ (3)

(In Formula, M3 represents at least one type selected from the group consisting of nickel (Ni), manganese (Mn), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W), and r, s, t, and u are values within the range of 0.8≦r≦1.2, 0≦s≦0.5, −0.1≦t≦0.2, and 0≦u≦0.1. In this regard, the composition of lithium is different depending on the charged or discharged state and the value of r indicates a value in a completely discharged state.)

LiᵥMn_{2-w}M4_{w}OₓF_{y} (4)

(In Formula, M4 represents at least one type selected from the group consisting of cobalt (Co), nickel (Ni), magnesium (Mg), aluminum (Al), boron (B), titanium (Ti), vanadium (V), chromium (Cr), iron (Fe), copper (Cu), zinc (Zn), molybdenum (Mo), tin (Sn), calcium (Ca), strontium (Sr), and tungsten (W), and v, w, x, and y are values within the range of 0.9≦v≦1.1, 0≦w≦0.6, 3.7≦x≦4.1, and 0≦y≦0.1. In this regard, the composition of lithium is different depending on the charged or discharged state and the value of v indicates a value in a completely discharged state.)

Li_{z}M5PO₄ (5)

(In Formula, M5 represents at least one type selected from the group consisting of cobalt (Co), manganese (Mn), iron (Fe), nickel (Ni), magnesium (Mg), aluminum (Al), boron (B), titanium (Ti), vanadium (V), niobium (Nb), copper (Cu), zinc (Zn), molybdenum (Mo), calcium (Ca), strontium (Sr), tungsten (W), and zirconium (Zr), and z is a value within the range of 0.9≦z≦1.1. In this regard, the composition of lithium is different depending on the charged or discharged state and the value of z indicates a value in a completely discharged state.)

Besides them, examples of positive electrode materials, which can absorb and release lithium, include inorganic compounds not containing lithium, e.g., MnO₂, V₂O₅, V₆O₁₃, NiS, and MoS, as well.

Negative Electrode

The negative electrode 22 has a structure in which, for example, negative electrode active material layers 22B are disposed on both surfaces of a negative electrode collector 22A. In this regard, although not shown in the drawing, the negative electrode active material layer 22B may be disposed on merely one surface of the negative electrode collector 22A. The negative electrode collector 22A is formed from, for example, metal foil, e.g., copper foil.

The negative electrode active material layer 22B is configured to contain at least one type of negative electrode material, which can absorb and release lithium, as the negative electrode active material and, if necessary, is configured to contain the same binder as that in the positive electrode active material layer 21B.

Furthermore, regarding this secondary battery, the electrochemical equivalent of the negative electrode material, which can absorb and release lithium, is specified to be larger than the electrochemical equivalent of the positive electrode 21 and, thereby, deposition of lithium metal on the negative electrode 22 during charging is prevented.

Moreover, this secondary battery is designed in such a way that the open circuit voltage (that is, battery voltage) at the time of complete charge becomes within the range of, for example, 4.2 V or more, and 4.6 V or less, and preferably 4.25 V or more, and 4.5 V or less. In the case where the open circuit voltage is designed to become within the range of 4.25 V or more, and 4.5 V or less, the amount of release of lithium per unit mass is larger than that of the battery having an open circuit voltage of 4.20 V even when the positive electrode active material is the same. Therefore, the amounts of the positive electrode active material and the negative electrode active material are adjusted in accordance with that. In this manner, a high energy density is obtained.

Examples of negative electrode materials, which can absorb and release lithium, include carbon materials, e.g., hard-to-graphitize carbon materials, easy-to-graphitize carbon materials, graphite, pyrolytic carbon, coke, glassy carbon, organic polymer compound fired products, carbon fibers, and activated carbon. Among them, the coke include pitch coke, needle coke, petroleum coke, and the like. The organic polymer compound fired products refer to products produced by firing polymer materials, e.g., phenol resins and furan resins, at appropriate temperatures so as to carbonize, some products are classified into the hard-to-graphitize carbon or easy-to-graphitize carbon. In this regard, examples of polymer materials include polyacetylenes and polypyrroles. These carbon materials are preferable because changes in crystal structure, which occur during charging and discharging, are very small extent, high charge and discharge capacities can be obtained and, in addition, a good cycle characteristic can be obtained. In particular, the graphite is preferable because an electrochemical equivalent is large and a high energy density is obtained. Alternatively, the hard-to-graphitize carbon is preferable because excellent characteristics are obtained. Alternatively, materials having low charge and discharge potentials, specifically materials having charge and discharge potentials close to that of lithium metal are preferable because a high energy density of battery can be realized easily.

Examples of negative electrode materials, which can absorb and release lithium, also include materials which can absorb and release lithium and which contain at least one type of metal elements and half metal elements as a constituent element. This is because a high energy density can be obtained by using such materials. In particular, the use in combination with the carbon material is more preferable because a high energy density can be obtained and, in addition, an excellent cycle characteristic can be obtained. The negative electrode materials may be simple substances, alloys, or compounds of metal elements or half metal elements or be materials having a phase of at least one type of them as at least a part thereof. In this regard, in the present invention, the alloys may include alloys containing at least one type of metal element and at least one type of half metal element, besides alloys composed of at least two types of metal elements. Furthermore, nonmetal elements may be included. Examples of structures thereof include a solid solution, an eutectic (eutectic mixture), an intermetallic compound, and a structure in which at least two types thereof coexist.

Examples of metal elements or half metal elements constituting the negative electrode materials include magnesium (Mg), boron (B), aluminum (Al), gallium (Ga), indium (In), silicon (Si), germanium (Ge), tin (Sn), lead (Pb), bismuth (Bi), cadmium (Cd), silver (Ag), zinc (Zn), hafnium (Hf), zirconium (Zr), yttrium (Y), palladium (Pd), and platinum (Pt). They may be crystalline or amorphous.

Among them, it is preferable that the negative electrode material contains group 4B metal elements or half metal elements in the short form periodic table as constituent elements. It is particularly preferable that at least one of silicon (Si) and tin (Sn) is contained as a constituent element. This is because silicon (Si) and tin (Sn) have a large capability of absorbing and releasing lithium (Li) and, therefore, high energy densities can be obtained.

Examples of tin (Sn) alloys include alloys containing at least one type selected from the group consisting of silicon (Si), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), and chromium (Cr) as the second constituent elements other than tin (Sn). Examples of silicon (Si) alloys include alloys containing at least one type selected from the group consisting of tin (Sn), nickel (Ni), copper (Cu), iron (Fe), cobalt (Co), manganese (Mn), zinc (Zn), indium (In), silver (Ag), titanium (Ti), germanium (Ge), bismuth (Bi), antimony (Sb), and chromium (Cr) as the second constituent elements other than silicon (Si).

Examples of tin (Sn) compounds and silicon compounds include compounds containing oxygen (O) or carbon (C), and the above-described second constituent elements may be contained in addition to tin (Sn) or silicon (Si).

Examples of negative electrode materials, which can absorb and release lithium, further include other metal compounds and polymer materials. Examples of other metal compounds include oxides, e.g., MnO₂, V₂O₅, and V₆O₁₃, sulfides, e.g., NiS and MoS, and lithium nitrides, e.g., LiN₃. Examples of polymer materials include polyacetylenes, polyanilines, and polypyrroles.

Separator

FIG. 3 is a sectional view showing a configuration example of a separator. A separator 23 is to separate the positive electrode 21 and the negative electrode 22 so as to pass lithium ions while preventing short-circuit of current due to contact of the two electrodes. The separator 23 includes a first layer 23A having a first principal surface and a second principal surface and a second layer 23B disposed on at least one of the two principal surfaces of the first layer 23A. It is preferable that the second layers 23B are disposed on both principal surfaces of the first layer 23A from the viewpoint of an improvement of the safety. In this regard, FIG. 3 shows the case where the second layers 23B are disposed on both principal surfaces of the first layer.

It is preferable that the average film thickness of the first layer 23A is within the range of 5 μm or more, and 50 μm or less. If the average film thickness exceeds 50 μm the ionic conductivity becomes poor and the battery characteristics deteriorate. Furthermore, the volume fraction made up by the separator 23 in the battery becomes too large, the volume fraction of the active material is reduced, and the battery capacity is reduced. If the average film thickness is less than 5 μm, the mechanical strength is too small, so that problems in rolling of the battery and reduction in safety of the battery result. It is preferable that the average film thickness of the second layer 23B is within the range of 0.5 μm or more, and 30 μm or less. If the average film thickness exceeds 30 μm, the volume fraction made up by the separator 23 in the battery becomes too large, the volume fraction of the active material is reduced, and the battery capacity is reduced. If the average film thickness is less than 0.5 μm, transfer to a contamination, which is shown in the present invention, is insufficient and, therefore, suppression of heat generation in short-circuit is not performed sufficiently.

The first layer 23A is a microporous film containing, for example, a polymer resin as a primary component. It is preferable that a polyolefin resin is used for the polymer resin. This is because the microporous film containing a polyolefin as a primary component has an excellent effect of preventing short-circuit and the safety of the battery can be improved on the basis of a shut down effect. As for the polyolefin resin, it is preferable that a simple substance of polypropylene or polyethylene or a mixture thereof is used. Furthermore, besides the polypropylene and the polyethylene, a resin having chemical stability can be used by being copolymerized or mixed with the polyethylene or the polypropylene.

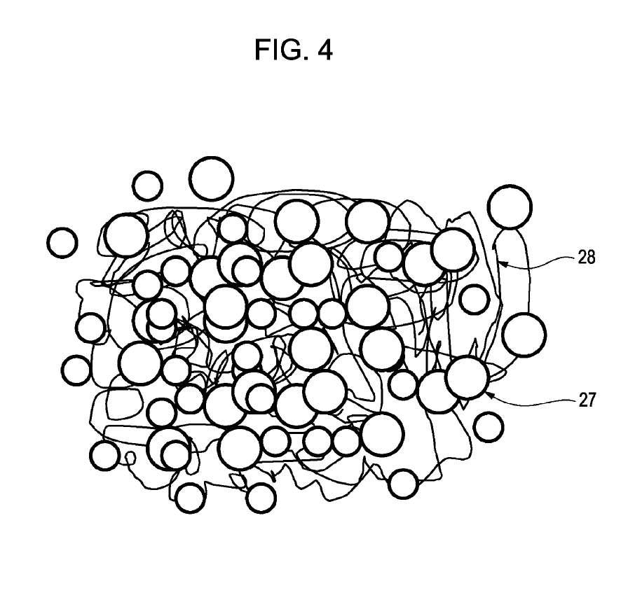

FIG. 4 is a schematic diagram showing a configuration example of the second layer of the separator. The second layer 23B is a porous functional layer containing particles 27 having an electrically insulating property and fibrils 28 having an average diameter of 1 μm or less. The fibrils 28 have a three-dimensional network structure (mesh structure) in which the fibrils are mutually linked continuously. It is preferable that particles are held in this network structure. Since the second layer 23B contains particles, when being transferred to a contamination, a sufficient insulating property is exhibited and the safety can be improved. Since the fibrils 28 have a three-dimensional network structure, in which the fibrils 28 are mutually linked continuously, gaps can be maintained, deterioration of battery characteristic (cycle characteristic) can be suppressed without impairing the ionic conductivity, and the flexibility can be given. Consequently, contaminations having any shape can be followed and the safety can be improved. If the average diameter of the fibrils 28 is 1 μm or less, particles sufficient for ensuring the insulating property can be held reliably even when the composition ratio of a component constituting the fibril is small, and the safety can be improved.

The particle is, for example, an inorganic particle having an electrically insulating property. The type of the inorganic particle is not specifically limited insofar as the inorganic particle has the electrically insulating property. However, it is preferable that a particle containing an inorganic oxide, e.g., alumina or silica, as a primary component is used.

The fibril contains, for example, a polymer resin, as a primary component. This polymer resin is not specifically limited insofar as the polymer resin can form a three-dimensional network structure in which the fibrils are mutually linked continuously. It is preferable that the average molecular weight of the polymer resin is within the range of 500,000 or more, and 2,000,000 or less. The above-described network structure can be obtained by specifying the average molecular weight to be 500,000 or more. If the average molecular weight is less than 500,000, particle holding force is small and, for example, peeling of a layer containing particles occurs. As for the polymer resin, a simple substance of polyacrylonitriles, polyvinylidene fluorides, copolymers of vinylidene fluoride and hexafluoropropylene, polytetrafluoroethylenes, polyhexafluoropropylenes, polyethylene oxides, polypropylene oxides, polyphosphazenes, polysiloxanes, polyvinyl acetates, polyvinyl alcohols, polymethyl methacrylates, polyacrylates, polymethacrylates, styrene-butadiene rubber, nitrile-butadiene rubber, polystyrenes, and polycarbonates or a mixture containing at least two types thereof can be used. As for the polymer resin, polyacrylonitriles, polyvinylidene fluorides, polyhexafluoropropylenes, and polyethylene oxides are preferable from the viewpoint of the electrochemical stability. Furthermore, it is preferable that fluororesins are used as the polymer resin from the viewpoint of the thermal stability and the electrochemical stability. Moreover, polyvinylidene fluorides are preferable as the polymer resin from the viewpoint of an improvement of the flexibility of the second layer 23B. In the case where the flexibility of the second layer 23B is improved, when the separator 23 is fractured due to an inclusion present between the electrode and the separator 23 and the second layer 23B is transferred to the inclusion, the shape conformability of the second layer 23B to the inclusion is improved and the safety is improved.

Alternatively, a heat-resistant resin may be used as the polymer resin. The insulating property and the heat resistance can be made mutually compatible by using the heat-resistant resin. As for the heat-resistant resin, a resin having a high glass transition temperature is preferable from the viewpoint of the dimensional stability in a high-temperature atmosphere. Alternatively, it is preferable that a resin having a melting entropy and not having a melting point is used as the polymer resin from the viewpoint of reduction in dimensional change due to fluidization and shrinkage. Examples of such resins include polyamides having aromatic skeletons, resins having aromatic skeletons and including imide bonds, and copolymers thereof.

It is the mechanism of performance of an insulating function of the separator 23 that when the separator 23 is fractured, the second layer 23B serving as the porous functional layer is transferred to a short-circuit source (an inclusion or the like). In consideration of the point that it is difficult to specify a position of inclusion of the short-circuit source in advance, it is preferable that the second layers 23B are disposed on both principal surfaces of the first layer 23A.

Preferably, the mass per unit area of the second layer 23B is 0.2 mg/cm² or more, and 3.0 mg/cm² or less. If the mass per unit area is less than 0.2 mg/cm², the resistance in short-circuit is reduced and the amount of heat generation in short-circuit increases, so that the safety is reduced. If 3.0 mg/cm² is exceeded, the safety can be ensured, but unfavorably, the separator 23 becomes thick, the volume fraction made up by the separator 23 in the battery becomes too large, the volume fraction of the active material is reduced, and the battery capacity is reduced.

It is preferable that the volume fraction of particles in the second layer 23B is 60 percent by volume or more, and 97 percent by volume or less. If the volume fraction is less than 60 percent by volume, the resistance in short-circuit is reduced and the amount of heat generation in short-circuit increases, so that the safety is reduced. Furthermore, in the case where the volume fraction is 0 percent by volume, the cycle characteristic also deteriorates. If 97 percent by volume is exceeded, the particle holding force of the resin is reduced, and fall of the powder occurs.

Preferably, the average particle diameter of the particles contained in the second layer 23B is within the range of 0.1 μm or more, and 1.5 μm or less. If the average particle diameter is less than 0.1 μm, when the second layer 23B is crushed through compression due to charging and discharging of the battery, the ionic conductivity is impaired and, for example, the cycle characteristic deteriorates. If the average particle diameter exceeds 1.5 μm, when the first layer 23A is fractured, it becomes difficult that the second layer 23B sufficiently covers a contact surface, which has been in contact with the separator 23 immediately before the fracture, in the surface of an inclusion, so that sufficient insulating property tends to become not obtained. Furthermore, problems in a coating step tends to increase.

Electrolytic Solution

The separator 23 is impregnated with an electrolytic solution, which is a liquid electrolyte. This electrolytic solution contains a solvent and an electrolytic salt dissolved in this solvent.

As for the solvent, cyclic carbonic acid esters, e.g., ethylene carbonate and propylene carbonate, can be used. It is preferable that at least one of ethylene carbonate and propylene carbonate, in particular, both of them are mixed and used. This is because the cycle characteristic can be improved.

As for the solvent, it is also preferable that a chain carbonic acid ester, e.g., diethyl carbonate, dimethyl carbonate, ethyl methyl carbonate, or methyl propyl carbonate, is mixed and used in addition to these cyclic carbonic acid esters. This is because a high ionic conductivity can be obtained.

Furthermore, as for the solvent, it is preferable that 2,4-difluoroanisole or vinylene carbonate is contained. This is because 2,4-difluoroanisole can improve the discharge capacity and vinylene carbonate can improve the cycle characteristic. Consequently, it is preferable that they are mixed and used because the discharge capacity and the cycle characteristic can be improved.

Besides them, examples of solvents include butylene carbonate, γ-butyrolactone, γ-valerolactone, 1,2-dimethoxyethane, tetrahydrofuran, 2-methyl tetrahydrofuran, 1,3-dioxolane, 4-methyl-1,3-dioxolane, methyl acetate, methyl propionate, acetonitrile, glutaronitrile, adiponitrile, methoxyacetonitrile, 3-methoxypropionitrile, N,N-dimethylformamide, N-methylpyrrolidinone, N-methyloxazolidinone, N,N-dimethylimidazolidinone, nitromethane, nitroethane, sulfolane, dimethylsulfoxide, and trimethyl phosphate.

In this regard, compounds produced by substituting at least a part of hydrogen of these nonaqueous solvent with fluorine may be preferable because, sometimes, the reversibility of the electrode reaction can be improved depending on the type of the electrodes combined.

Examples of electrolytic salts include lithium salts. One type may be used alone, and at least two types may be mixed and used. Examples of lithium salts include LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiAlCl₄, LiSiF₆, LiCl, lithium difluolo[oxolato-O,O′]borate, lithium bis(oxalato)borate, and LiBr. Most of all, LiPF₆ is preferable because a high ionic conductivity can be obtained and, in addition, the cycle characteristic can be improved.

Function of Separator in Short-Circuit

Regarding the separator 23 having the above-described configuration, in the case where an inclusion is present between the electrode and the separator 23 and the first layer 23A of the separator 23 is fractured, the second layer is interposed between the inclusion and the electrode. Consequently, insulation between the inclusion and the electrode is ensured.

Specifically, for example, in the case where the first layer 23A of the separator 23 is fractured, the second layer 23B is transferred to a contact surface, which has been in contact with the separator 23 immediately before the fracture, in the surface of the inclusion. It is preferable that the first layer 23A is fractured in such a way that the second layer 23B covers the above-described contact surface from the viewpoint of suppression of heat generation in fracture of the separator 23.

In the case where the second layer 23B is disposed on merely one surface of the first layer 23A, the short-circuit resistance tends to be varied depending on the position of disposition of an inclusion. That is, in the case where the inclusion is located on the side, on which the second layer 23B is disposed, when the first layer 23A is fractured, almost whole contact surface, which has been in contact with the separator 23 immediately before the fracture, in the surface of the inclusion tends to be covered with the second layer 23B. On the other hand, in the case where the inclusion is located on the side, on which the second layer 23B is not disposed, when the first layer 23A is fractured, merely a part of the contact surface, which has been in contact with the separator 23 immediately before the fracture, in the surface of the inclusion tends to be covered with the second layer 23B. Therefore, in order to obtain higher safety, it is preferable that the second layers 23B are disposed on both principal surfaces of the first layer 23A.

Short-Circuit Test

The separator 23 having the above-described configuration is a separator capable of obtaining a short-circuit resistance of 1Ω or more when the following short-circuit test is conducted.

Initially, the separator 23 having the above-described configuration is sandwiched between copper foil and aluminum foil, and a nickel piece specified in the item JIS C8714 5.5.2 is disposed between the copper foil or the aluminum foil and the separator 23. Then, a voltage of 12 V in a constant-current condition of 25 A is applied between the copper foil and the aluminum foil, and the nickel piece is pressurized with 98 N (10 kgf). The short-circuit resistance at this time is 1Ω or more.

In the case where the short-circuit resistance is 1Ω or more, generation of a large current can be suppressed and an occurrence of abnormal heat generation can be suppressed. Consequently, the safety can be improved. In this regard, it is preferable that the total amount of heat generation within 1 second from the time of occurrence of the short-circuit in the above-described short-circuit test is 10 J or less. In the case where the total amount of heat generation is 10 J or less, the safety can be improved.

Method for Manufacturing Battery

Next, an example of a method for manufacturing a nonaqueous electrolyte secondary battery according to the first embodiment of the present invention will be described.

Initially, for example, the positive electrode active material, the electrically conductive agent, and the binder are mixed, so as to prepare a positive electrode mix. The resulting positive electrode mix is dispersed into a solvent, e.g., N-methyl-2-pyrrolidone, so as to produce a paste-like positive electrode mix slurry. Subsequently, the resulting positive electrode mix slurry is applied to the positive electrode collector 21A, and the solvent is dried. Then, compression molding is conducted with a roll-pressing machine or the like, so as to form the positive electrode active material layer 21B and, thereby, form the positive electrode 21.

Furthermore, for example, the negative electrode active material and the binder are mixed, so as to prepare a negative electrode mix. The resulting negative electrode mix is dispersed into a solvent, e.g., N-methyl-2-pyrrolidone, so as to produce a paste-like negative electrode mix slurry. Subsequently, the resulting negative electrode mix slurry is applied to the negative electrode collector 22A, and the solvent is dried. Then, compression molding is conducted with a roll-pressing machine or the like, so as to form the negative electrode active material layer 22B and, thereby, produce the negative electrode 22.

Next, a positive electrode lead 25 is attached to the positive electrode collector 21A through welding or the like and, in addition, a negative electrode lead 26 is attached to the negative electrode collector 22A through welding or the like. Then, the positive electrode 21 and the negative electrode 22 are rolled with the separator 23 therebetween. Thereafter, an end portion of the positive electrode lead 25 is welded to the safety valve mechanism 15 and, in addition, an end portion of the negative electrode lead 26 is welded to the battery can 11. The rolled positive electrode 21 and the negative electrode 22 are sandwiched between a pair of insulating plates 12 and 13, and are held into the inside of the battery can 11. After the positive electrode 21 and the negative electrode 22 are held into the inside of the battery can 11, the electrolytic solution is injected into the inside of the battery can 11, so that the separator 23 is impregnated therewith. Subsequently, a battery lid 14, the safety valve mechanism 15, and a positive temperature coefficient element 16 are fixed to an open end portion of the battery can 11 by swaging with a sealing gasket 17 therebetween. In this manner, the secondary battery shown in FIG. 1 is obtained.

Regarding the secondary battery according to this first embodiment, the open circuit voltage in a fully charged state is within the range of, for example, 4.2 V or more, and 4.6 V or less, and preferably 4.25 V or more, and 4.5 V or less. This is because in the case where the open circuit voltage is 4.25 V or more, the utilization factor of the positive electrode active material can increase, so that a larger extent of energy can be taken and in the case of 4.5 V or less, oxidation of the separator 23, a chemical change of the electrolytic solution, and the like can be suppressed.

Regarding the secondary battery according to this first embodiment, when charging is conducted, lithium ions are released from the positive electrode active material layer 21B, and are absorbed by the negative electrode material, which is contained in the negative electrode active material layer 22B and which can absorb and release lithium, through the electrolytic solution. Subsequently, when discharging is conducted, lithium ions absorbed in the negative electrode material, which can absorb and release lithium, in the negative electrode active material layer 22B are released and absorbed by the positive electrode active material layer 21B through the electrolytic solution.

In the case where contamination or dendride occurs, the separator according to the first embodiment can suppress an occurrence of short-circuit or reduce the area of short-circuit even when short-circuit occurs. Consequently, generation of a large current can be suppressed. On the other hand, regarding a single-layer polyolefin separator in the past, in the case where contamination or dendride occurs, there is a high risk of an occurrence of large-current short-circuit.

Furthermore, regarding the separator according to the first embodiment, the short-circuit area is reduced and, thereby, continual occurrence of short-circuit for a long time is suppressed, so that the amount of generation of Joule's heat can be reduced. Moreover, in the case where the separator 23 including the first layer 23A produced by drawing an olefin resin is used, the function can be performed favorably without impairing the shutdown function of the first layer 23A.

### 2. Second Embodiment

Configuration of Battery

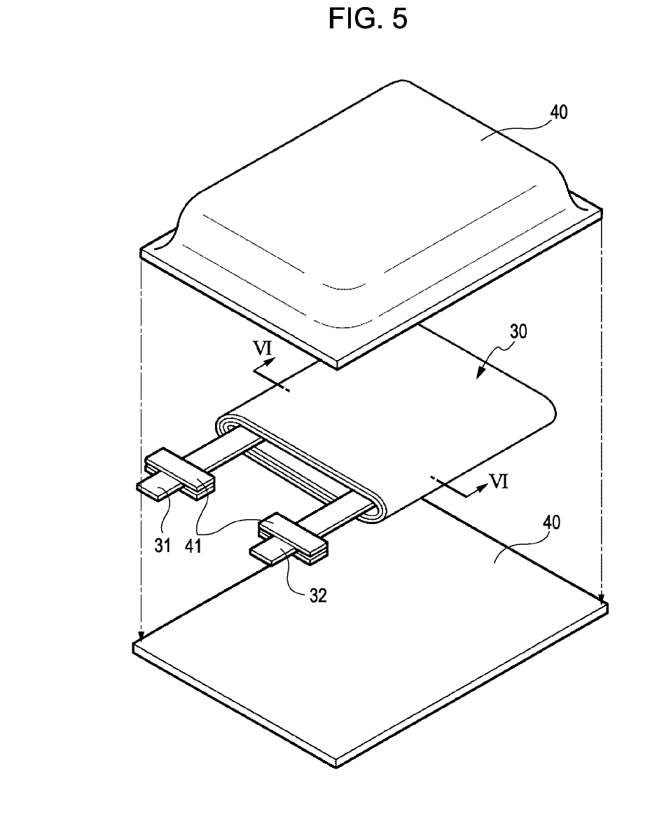

FIG. 5 is an exploded perspective view showing a configuration example of a nonaqueous electrolyte secondary battery according to a second embodiment of the present invention. In this secondary battery, a rolled electrode member 30, to which a positive electrode lead 31 and a negative electrode lead 32 are attached, is held in the inside of a film-shaped outer case member 40, and miniaturization, weight reduction, and thickness reduction can be facilitated.

Each of the positive electrode lead 31 and the negative electrode lead 32 is led from the inside of the outer case member 40 toward the outside, for example, in the same direction. Each of the positive electrode lead 31 and the negative electrode lead 32 is formed from a metal material, e.g., aluminum, copper, nickel, or stainless steal, and is in the shape of a thin sheet or a mesh.

The outer case member 40 is formed from, for example, a rectangular aluminum laminate film, in which a nylon film, aluminum foil, and a polyethylene film are bonded together in that order. The outer case member 40 is disposed in such a way that, for example, the polyethylene film side and the rolled electrode member 30 are opposed to each other, and individual outer edge portions are mutually adhered through fusion or with an adhesive. Adhesion films 41 for preventing intrusion of the outside air are inserted between the outer case member 40 and the positive electrode lead 31 and between the outer case member 40 and the negative electrode lead 32. The adhesion film 41 is formed from a material, for example, an polyolefin resin, e.g., polyethylene, polypropylene, modified polyethylene, or modified polypropylene, which has adhesion to the positive electrode lead 31 and the negative electrode lead 32.

In this regard, the outer case member 40 may be formed from a laminate film having another structure, a polymer film, e.g., a polypropylene film, or a metal film instead of the above-described aluminum laminate film.

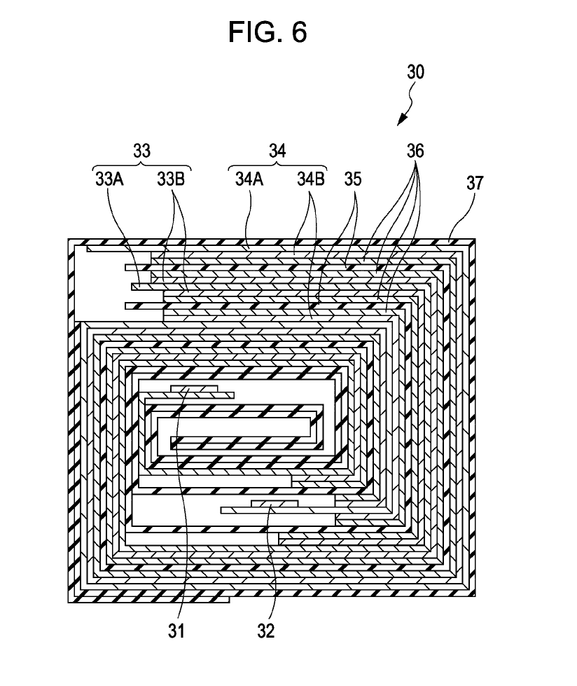

FIG. 6 is a sectional view of the section of the rolled electrode member 30 shown in FIG. 5, taken along a line VI-VI shown in FIG. 5. The rolled electrode member 30 is produced by laminating a positive electrode 33 and a negative electrode 34 with a separator 35 and an electrolyte layer 36 therebetween and rolling them. An outermost circumferential portion is protected by a protective tape 37.

The positive electrode 33 has a structure in which a positive electrode active material layer 33B is disposed on one surface or both surfaces of the positive electrode collector 33A. The negative electrode 34 has a structure in which a negative electrode active material layer 34B is disposed on one surface or both surfaces of the negative electrode collector 34A. The negative electrode active material layer 34B and the positive electrode active material layer 33B are disposed in such a way as to oppose to each other. The configurations of the positive electrode collector 33A, the positive electrode active material layer 33B, the negative electrode collector 34A, the negative electrode active material layer 34B, and the separator 35 are the same as those of the positive electrode collector 21A, the positive electrode active material layer 21B, the negative electrode collector 22A, the negative electrode active material layer 22B, and the separator 23, respectively, in the first embodiment.

The electrolyte layer 36 contains an electrolytic solution and a polymer compound serving as a holder to hold this electrolytic solution and is in the state of so-called gel. The gel-like electrolyte layer 36 is preferable because a high ionic conductivity can be obtained and, in addition, leakage of liquid of the battery can be prevented. The configuration of the electrolytic solution (that is, the solvent, the electrolytic salt, and the like) is the same as that of the secondary battery according to the first embodiment. Examples of polymer compounds include polyacrylonitriles, polyvinylidene fluorides, copolymers of polyvinylidene fluoride and polyhexafluoropropylene, polytetrafluoroethylenes, polyhexafluoropropylenes, polyethylene oxides, polypropylene oxides, polyphosphazenes, polysiloxanes, polyvinyl acetates, polyvinyl alcohols, polymethyl methacrylates, polyacrylates, polymethacrylates, styrene-butadiene rubber, nitrile-butadiene rubber, polystyrenes, and polycarbonates. In particular, polyacrylonitriles, polyvinylidene fluorides, polyhexafluoropropylenes, and polyethylene oxides are preferable from the viewpoint of the electrochemical stability.

Method for Manufacturing Battery

Next, an example of a method for manufacturing the nonaqueous electrolyte secondary battery according to the second embodiment of the present invention will be described.

Initially, a precursor solution containing a solvent, an electrolytic salt, a polymer compound, and a mixed solvent is applied to each of the positive electrode 33 and the negative electrode 34. The mixed solvent is volatilized so as to form the electrolyte layer 36. Thereafter, a positive electrode lead 31 is attached to an end portion of the positive electrode collector 33A through welding and, in addition, a negative electrode lead 32 is attached to an end portion of the negative electrode collector 34A through welding. Then, the positive electrode 33 and the negative electrode 34, each provided with the electrolyte layer 36, are laminated with the separator 35 therebetween, so as to produce a laminate. The resulting laminate is rolled in the longitudinal direction thereof and a protective tape 37 is bonded to the outermost circumferential portion, so that the rolled electrode member 30 is formed. Finally, for example, the rolled electrode member 30 is sandwiched between the outer case member 40, outer edge portions of the outer case member 40 are mutually adhered through heat-fusion or the like so as to seal. At that time, adhesion films 41 are inserted between the positive electrode lead 31 and the outer case member 40 and between the negative electrode lead 32 and the outer case member 40. In this manner, the secondary battery shown in FIG. 5 and FIG. 6 is obtained.

Alternatively, this secondary battery may be produced as described below. Initially, the positive electrode 33 and the negative electrode 34 are produced as described above. The positive electrode lead 31 and the negative electrode lead 32 are attached to the positive electrode 33 and the negative electrode 34. Thereafter, the positive electrode 33 and the negative electrode 34 are laminated with the separator 35 therebetween, followed by rolling. A protective tape 37 is bonded to the outermost circumferential portion, so that a rolled member serving as a precursor of the rolled electrode member 30 is formed. Subsequently, the resulting rolled member is sandwiched between the outer case member 40, outer edge portions except one side are heat-fused, so that the shape of a bag results and the rolled member is held in the inside of the outer case member 40. Then, an electrolyte-forming composition containing a solvent, an electrolytic salt, a monomer serving as a raw material for a polymer compound, a polymerization initiator, and if necessary, other materials, e.g., a polymerization inhibitor, is prepared and is injected into the inside of the outer case member 40.

After the electrolyte-forming composition is injected, an opening portion of the outer case member 40 is heat-fused under a vacuum atmosphere, so as to seal. Next, heat is applied to polymerize the monomer to a polymer compound, so that a gel-like electrolyte layer 36 is formed. In this manner, the secondary battery shown in FIG. 5 is obtained.

The operation and the effect of the nonaqueous electrolyte secondary battery according to this second embodiment is similar to those of the nonaqueous electrolyte secondary battery according to the first embodiment.

### EXAMPLES

The present application will be specifically described below with reference to the examples. However, the present application is not limited to merely these examples.

In the present application, individual physical values were determined as described below.

Molecular Weight of PVdF

The measurement was conducted by a gel permeation chromatography (GPC) method at a temperature of 40° C. and a flow rate of 10 ml/min, so as to determine the molecular weight in terms of polystyrene. As for the solvent, N-methyl-2-pyrrolidone (NMP) was used.

Average Particle Diameter of Particles

The average particle diameter d50 of particles was determined by using an X-ray absorption type particle size analyzer (trade name: SediGraph III 5120, produced by Titan Technologies, Inc.).

Surface Density of Second Layer

The weight of a separator, which was cut into the length of 30 cm and which included a first layer and a second layer, was measured, and the weight per unit area was calculated. The weight per unit area of the first layer, which was measured in advance, was subtracted therefrom, so that the surface density of the second layer was determined.

Volume Fraction of Particles in Second Layer

The volume fraction was determined on the basis of the following formula by using the volume ratio of inorganic particles and the volume ratio of a resin.

volume fraction (percent by volume)=((volume ratio of inorganic particles)/(volume ratio of inorganic particles+volume ratio of resin))×100

Method for Calculating Average Diameter of Fibrils

Initially, the fibril structure of the second layer was photographed with a scanning electron microscope (SEM) under magnification of 10,000 times. Subsequently, ten fibrils were selected at random from the resulting SEM photograph, and diameters of individual fibrils were measured. Then, the measured values were simply averaged (arithmetic average), so as to determine the average diameter of the fibrils.

Sample 1

Preparation of Paint

Initially, a polyvinylidene fluoride (PVdF) resin having an average molecular weight of about 1,000,000 was dissolved into N-methyl-2-pyrrolidone (NMP) in such a way that 2 percent by weight was reached. Subsequently, alumina particles having an average particle diameter of 0.47 μm were put into the resulting PVdF/NMP solution in such a way that PVdF:alumina particles=10:90 (volume fraction) was satisfied. After agitation was conducted until homogeneous slurry was produced, mesh pass was conducted, so as to produce a paint.

Coating Step

Next, the above-described paint was applied with a tabletop coater to both surfaces of a polyethylene microporous film (first layer) having a thickness of 16 Then, phase separation was conducted in a water bath and, thereafter, drying was conducted, so that second layers were formed on both surfaces of the polyethylene microporous film serving as the first layer. In this manner, a desired separator was obtained.

Sample 2

A separator was obtained in a manner similar to that in Sample 1 except that the volume fraction of the alumina particles in the second layer was specified to be 82.0 percent by volume.

Sample 3

A separator was obtained in a manner similar to that in Sample 1 except that the volume fraction of the alumina particles in the second layer was specified to be 69.0 percent by volume.

Sample 4

A separator was obtained in a manner similar to that in Sample 1 except that silica particles having an average particle diameter of 0.80 μm were used as particles added to the paint and, in addition, the volume fraction of the silica particles in the second layer was specified to be 73.0 percent by volume and the surface density was specified to be 0.5 mg/cm².

Sample 5

A separator was obtained in a manner similar to that in Sample 1 except that the surface density of the second layer was specified to be 1.2 mg/cm².

Sample 6

A separator was obtained in a manner similar to that in Sample 1 except that silica particles having an average particle diameter of 0.80 μm were used as particles added to the paint and, in addition, the volume fraction of the silica particles in the second layer was specified to be 95.0 percent by volume and the surface density was specified to be 0.5 mg/cm².

Sample 7

A separator was obtained in a manner similar to that in Sample 1 except that the surface density of the second layer was specified to be 0.2 mg/cm².

Sample 8

A separator was obtained in a manner similar to that in Sample 1 except that the average particle diameter of the alumina particles added to the paint was specified to be 1.00 μm.

Sample 9

A separator was obtained in a manner similar to that in Sample 6 except that the particle diameter of silica particles added to the paint was specified to be 1.20 μm and the surface density was specified to be 0.2 mg/cm².

Sample 10

A separator was obtained in a manner similar to that in Sample 7 except that the paint was applied to merely one surface of a polyethylene microporous film serving as the first layer and the second layer was formed on one surface of the polyethylene microporous film (first layer).

Sample 11

A separator was obtained in a manner similar to that in Sample 1 except that the paint was applied to merely one surface of a polyethylene microporous film serving as the first layer and the second layer was formed on one surface of the polyethylene microporous film (first layer).

Sample 12

A separator was obtained in a manner similar to that in Sample 5 except that the paint was applied to merely one surface of a polyethylene microporous film serving as the first layer and the second layer was formed on one surface of the polyethylene microporous film (first layer).

Sample 13

A separator was obtained in a manner similar to that in Sample 1 except that the volume fraction of the particles in the second layer was specified to be 57.0 percent by volume.

Sample 14

A separator was obtained in a manner similar to that in Sample 1 except that no particle was added to the paint, the volume fraction of the particles in the second layer was specified to be 0 percent by volume, and the surface density was specified to be 0.4 mg/cm².

Sample 15

A separator was obtained in a manner similar to that in Sample 1 except that the surface density of the second layer was specified to be 0.1 mg/cm².

Sample 16

A separator was obtained in a manner similar to that in Sample 1 except that silica particles having an average particle diameter of 0.80 μm were used as particles added to the paint and, in addition, the volume fraction of the silica particles in the second layer was specified to be 95.0 percent by volume and the surface density was specified to be 0.1 mg/cm².

Sample 17

A separator was obtained in a manner similar to that in Sample 1 except that the average particle diameter of the alumina particles added to the paint was specified to be 2.00 μm.

Sample 18

A separator was obtained in a manner similar to that in Sample 1 except that alumina particles having an average particle diameter of 0.013 μm were used as particles added to the paint and, in addition, the volume fraction in the second layer was specified to be 64.0 percent by volume and the surface density was specified to be 0.3 mg/cm².

Sample 19

A separator was obtained in a manner similar to that in Sample 1 except that the average particle diameter of the alumina particles added to the paint was specified to be 0.10 μm.

Sample 20

A separator was obtained in a manner similar to that in Sample 1 except that the average particle diameter of the alumina particles added to the paint was specified to be 1.50 μm.

Sample 21

A separator was obtained in a manner similar to that in Sample 1 except that silica particles having an average particle diameter of 0.05 μm were used as particles added to the paint and, in addition, the volume fraction of the silica particles in the second layer was specified to be 64.0 percent by volume and the surface density was specified to be 0.4 mg/cm².

Sample 22

A separator was obtained in a manner similar to that in Sample 1 except that silica particles having an average particle diameter of 1.70 μm were used as particles added to the paint and, in addition, the volume fraction of the silica particles in the second layer was specified to be 90.0 percent by volume and the surface density was specified to be 0.6 mg/cm².

Sample 23

The above-described paint was applied with a tabletop coater to both surfaces of a polyethylene microporous film (first layer) having a thickness of 16 μm. Subsequently, a separator was obtained in a manner similar to that in Sample 1 except that phase separation in a water bath was not conducted, drying was conducted in a constant-temperature bath at 40° C. and, thereby, the second layer did not have a network structure.

Sample 24

A mixture produced by mixing an ultrahigh molecular weight polyethylene having a weight average molecular weight of 2,000,000 and a very high density polyethylene having a weight average molecular weight of 700,000 and liquid paraffin serving as a solvent were mixed at a mass ratio of 30:70 so as to come into the state of slurry. Alumina particles were mixed therein in such a way that polyethylene:alumina particles=10:90 (volume fraction) was satisfied. This was dissolved and kneaded by using a twin-screw kneader at a temperature of 180° C. Then, the resulting kneaded product was sandwiched between metal plates cooled to 0° C., and was quenched and pressed so as to be formed into the shape of a sheet having a thickness of 2 mm. The resulting sheet was biaxially drawn by a factor of 4 times×4 times in longitudinal and transverse directions simultaneously at a temperature of 110° C. However, the film was broken during drawing, so that it was difficult to form a film.

Sample 25

A separator was obtained in a manner similar to that in Sample 19 except that the solid concentration of the paint was increased in such a way that the fibril diameter became 1.1

Sample 26

A separator was obtained in a manner similar to that in Sample 1 except that the volume fraction of the alumina particles in the second layer was specified to be 60.0 percent by volume and the surface density was specified to be 0.5 mg/cm².

Sample 27

A separator was obtained in a manner similar to that in Sample 1 except that silica particles having an average particle diameter of 0.80 μm were used as particles added to the paint and, in addition, the volume fraction of the silica particles in the second layer was specified to be 97.0 percent by volume.

Sample 28

A separator was obtained in a manner similar to that in Sample 1 except that the surface density of the second layer was specified to be 3.0 mg/cm².

Sample 29

A separator was obtained in a manner similar to that in Sample 1 except that the surface density of the second layer was specified to be 3.2 mg/cm².

Sample 30

A separator was obtained in a manner similar to that in Sample 1 except that the volume fraction of the alumina particles in the second layer was specified to be 98.0 percent by volume.

Evaluation of Structure of Second Layer

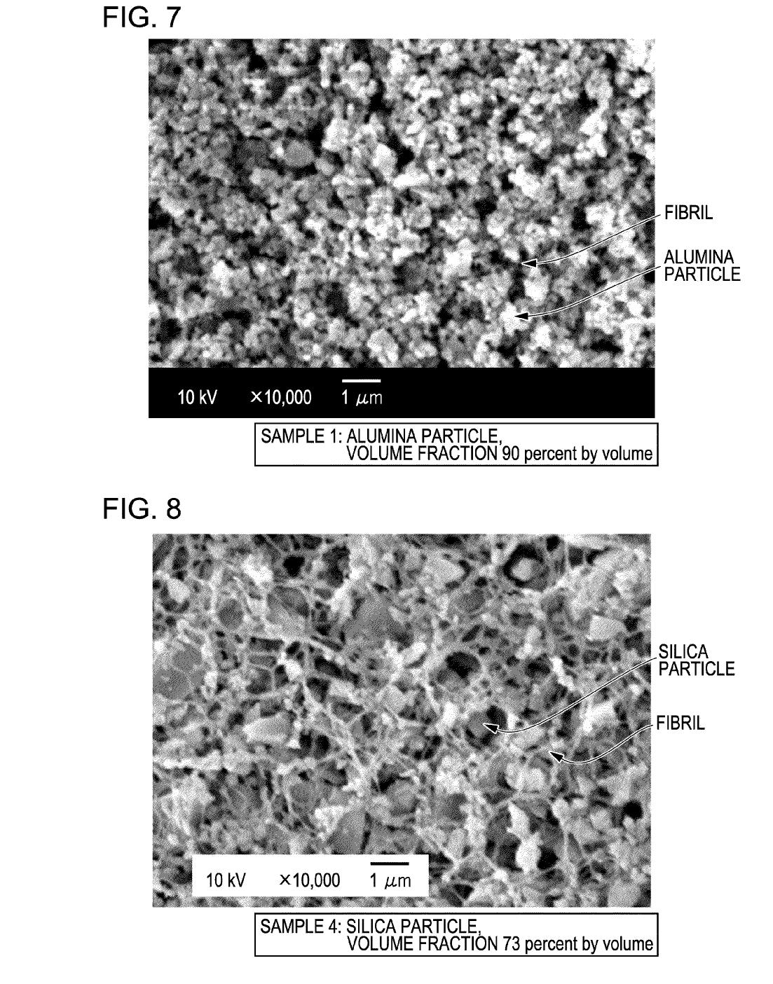

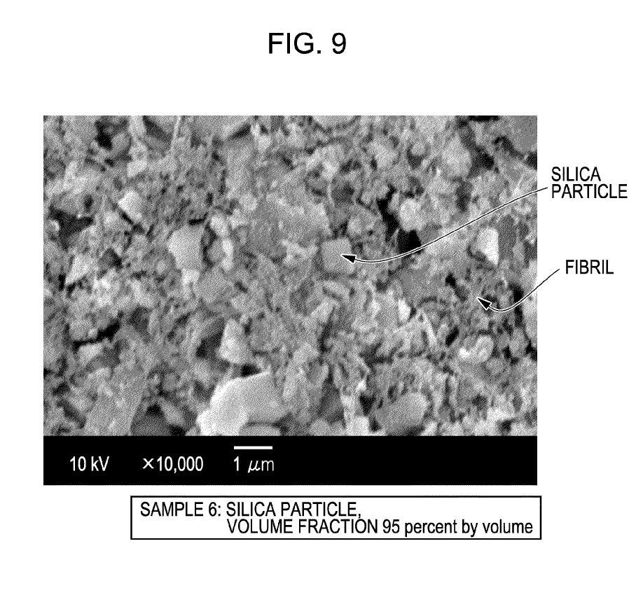

The structures of the second layers in the separators of Samples 1 to 30 obtained as described above were observed by using a scanning electron microscope (SEM). The observation results thereof are shown in Table 2 and Table 4. Furthermore, SEM photographs of the second layers of the separators of Samples 1, 4, and 6, among Samples 1 to 30, are shown in FIG. 7, FIG. 8, and FIG. 9, respectively.

Short-Circuit Test

The separators of Samples 1 to 30 obtained as described above were subjected to a short-circuit test.

It is believed that in the case where an inclusion is present in the battery in practice, the inclusion sticks into the active material or a collector foil through a separator due to expansion of the electrode because of charging, and short-circuit occurs due to mechanical fracture of the separator. In order to reproduce this phenomenon, it is necessary that the force during compression in the short-circuit test of the present example is such an extent that a nickel piece serving as a test piece sticks sufficiently into metal foil and a polypropylene plate and the separator is damaged sufficiently. According to the findings of the present inventors, about 6 kg/cm² of pressure is necessary and sufficient for subjecting the separator to such damage. In the short-circuit test of the present example, the force during compression was specified to be 98 N (10 kg) in consideration of an indenter area of the nickel piece.

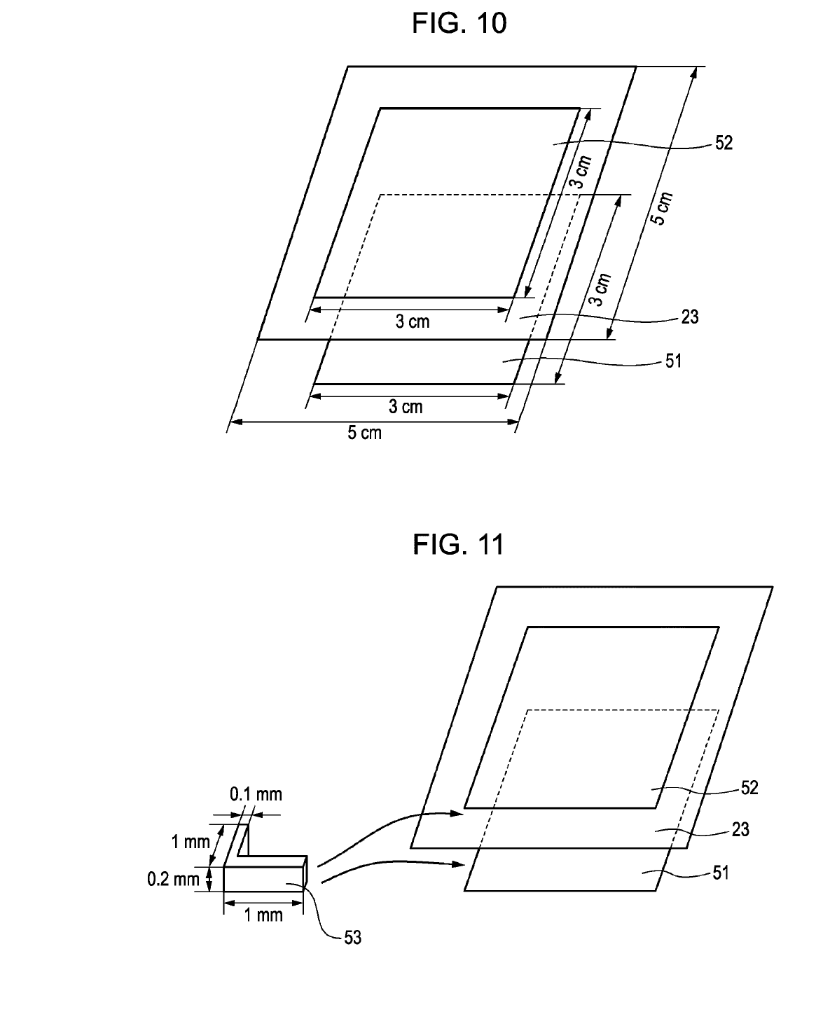

The detail of the short-circuit test will be described below with reference to FIG. 10 to FIG. 12.

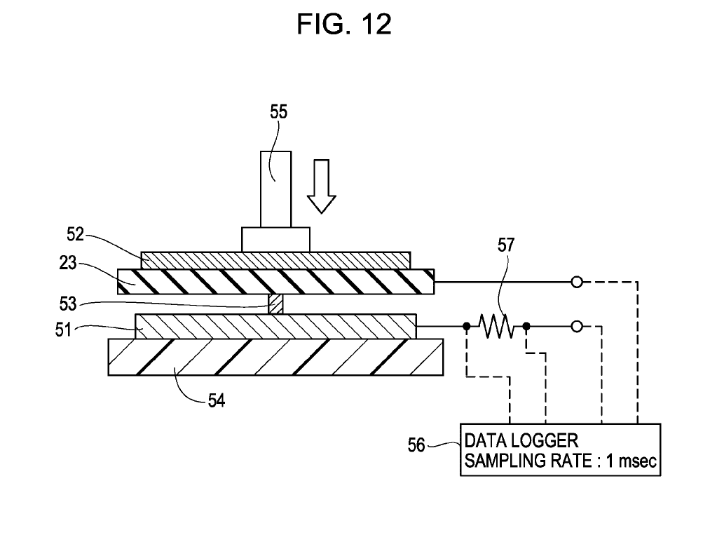

Initially, as shown in FIG. 10, each of aluminum foil 51 and copper foil 52 was cut into an about 3 cm square, and the separator 23 cut into a 5 cm square was disposed in such a way as to be sandwiched therebetween. Subsequently, as shown in FIG. 11, a letter L shaped nickel piece 53, which is specified in the item JIS C8712 5.5.2, was disposed between the separator 23 and the aluminum foil 51 or between the separator 23 and the copper foil 52, so that a test sample was obtained. At this time, the nickel piece 53 was disposed in such a way that the letter L shaped surfaces came into contact with the separator 23 and the aluminum foil 51 or the copper foil 52.

Then, as shown in FIG. 12, the aluminum foil 51 and the copper foil 52 were connected to a power supply (12 V, 25 A), the test sample was disposed on a polypropylene plate 54 in such a way that the aluminum foil 51 side of the test sample was on the side of the polypropylene plate 54. Thereafter, the test sample was compressed from above the test sample at a rate of 0.1 mm/sec. At this time, a circuit voltage, both terminal voltages of a shunt resistor 57 of 0.1Ω disposed in series in the circuit, and a load cell 55 attached to the indenter were recorded with a data logger 56 at a sampling rate of 1 msec.

Next, compression was conducted until the load cell 55 attached to the indenter indicated 98 N and, thereby, the separator 23 was fractured and the resistance in the short-circuit was calculated from the voltage and the current (calculated from the shunt resistor voltage). The resistance value was calculated from the average voltage and the average current in 1 second after the short-circuit occurred. Then, the joule's heat Q=I²R was calculated by using the calculated current value I and resistance value R.

In the case where the short-circuit resistance value in this test is 1Ω or more, generation of a large current can be suppressed and an occurrence of abnormal heat generation can be suppressed. Consequently, the safety can be improved. In this regard, in the case where the total amount of heat generation within 1 second after the occurrence of the short-circuit (amount of heat generation in short-circuit) is 10 J or less, generation of a large current can be suppressed and an occurrence of abnormal heat generation can be suppressed. Consequently, the safety can be improved.

Evaluation of Transfer

After the above-described short-circuit test, the surface, which had been in contact with the second layer, of the nickel piece was observed by using an optical microscope. It was judged visually that the surface, to which the second layer had been transferred, was “transfer” and the surface, to which the second layer had not been transferred, was “no transfer”.

Furthermore, the degree of transfer of the second layer was evaluated on the basis of the following criteria. In this regard, it is preferable that the area of the transfer of the second layer is maximized and there is no dropout in the transferred portion.

A: Transfer to not only the contact surface, but also a side surface of the nickel piece is observed sufficiently.

B: Transfer to merely the contact surface of the nickel piece is observed or transfer is sparse.

C: No transfer to the nickel piece is observed or transfer is a very little.

Evaluation of Cycle Characteristic

The separators of Samples 1 to 30 obtained as described above were used. A 18650 size circular cylinder type battery was produced as described below, and the cycle characteristic was evaluated.

Initially, 98 parts by mass of lithium cobaltate, 1.2 parts by mass of polyvinylidene fluoride, and 0.8 parts by mass of carbon black were dispersed into N-methyl-2-pyrrolidone serving as a solvent, so as to obtain a positive electrode mix slurry. This was applied to both surfaces of the aluminum foil having a thickness of 15 μm and serving as the positive electrode collector, followed by drying. Thereafter, pressing was conducted to form a positive electrode mix layer, so that a positive electrode was obtained.

On the other hand, 90 parts by mass of artificial graphite and 10 parts by mass of polyvinylidene fluoride were dispersed into N-methyl-2-pyrrolidone serving as a solvent, so as to obtain a negative electrode mix slurry. This was applied to both surfaces of the copper foil having a thickness of 15 μm and serving as the negative electrode collector, followed by drying. Thereafter, pressing was conducted to form a negative electrode mix layer, so that a negative electrode was obtained.

Next, a positive electrode lead was attached to the positive electrode collector through welding or the like and, in addition, a negative electrode lead was attached to the negative electrode collector through welding. Then, the positive electrode and the negative electrode were rolled with the separator therebetween. An end portion of the positive electrode lead was welded to a safety valve mechanism and, in addition, an end portion of the negative electrode lead was welded to the battery can. The rolled positive electrode and the negative electrode were sandwiched between a pair of insulating plates, and were held into the inside of the battery can. After the positive electrode and the negative electrode were held into the inside of the battery can, an electrolytic solution was injected into the inside of the battery can, so that the separator was impregnated therewith. Subsequently, a battery lid was fixed to the battery can by swaging with a gasket having a surface coated with asphalt therebetween, so that a 18650 size circular cylinder type battery was obtained.

In this regard, the separator of Sample 29 had a large film thickness and, therefore, it was difficult to insert into a 18650 size circular cylinder type battery. Consequently, the electrode was made thinner, the electrode density was reduced relative to the circular cylinder type battery and, thereby, adjustment was conducted in such a way that the separator was able to be inserted into the circular cylinder type battery. Then, the cycle characteristic was evaluated.

Next, the cycle characteristic of the circular cylinder type battery obtained as described above was evaluated as described below.

Initially, constant current charge at 1C was conducted until the upper limit voltage of 4.2 V was reached. Thereafter, discharge was conducted to a voltage of 3.00 V at 1C, and the discharge capacity in the first cycle was determined. Subsequently, charging and discharging were repeated under the same condition as that in the case where the discharge capacity in the 1st cycle was measured, and the discharge capacity in the 200th cycle was determined. In this regard, “1C” refers to a current value that discharges the rated capacity of the battery over 1 hour at the constant current. Next, the discharge capacity maintenance factor after 200 cycles was determined on the basis of the following formula by using the discharge capacity in the 1st cycle and the discharge capacity in the 200th cycle. The results thereof are shown in Table 2 and Table 4.

discharge capacity maintenance factor (%) after 200 cycles=(discharge capacity in the 200th cycle/discharge capacity in the 1st cycle)×100

Then, the cycle characteristic was evaluated as described below. The evaluation results thereof are shown in Table 2 and Table 4.

◯: discharge capacity maintenance factor after 200 cycles is 80% or more ×: discharge capacity maintenance factor after 200 cycles is less than 80%

Table 1 to Table 8 show the configurations of the separators of Samples 1 to 30 and the evaluation results thereof.

TABLE 1

| | | Second layer | | | | | | |
|---|---|---|---|---|---|---|---|---|
| | | | Average | | Volume | | | |
| | | | particle | | fraction of | Surface | | |
| | | | diameter | | particle | density | | |
| | First layer | Particle | d50(μm) | Resin | (vol %) | (mg/cm²) | Coating surface | Remarks |
| Sample 1 | Polyethylene | alumina | 0.47 | PVdF | 90.0 | 0.6 | both surfaces of first layer | volume fraction of |
| Sample 2 | Polyethylene | alumina | 0.47 | PVdF | 82.0 | 0.6 | both surfaces of first layer | particle is different |
| Sample 3 | Polyethylene | alumina | 0.47 | PVdF | 69.0 | 0.6 | both surfaces of first layer | |
| Sample 4 | Polyethylene | silica | 0.80 | PVdF | 73.0 | 0.5 | both surfaces of first layer | |
| Sample 5 | Polyethylene | alumina | 0.47 | PVdF | 90.0 | 1.2 | both surfaces of first layer | surface density is |
| | | | | | | | | different (large) |
| Sample 6 | Polyethylene | silica | 0.80 | PVdF | 95.0 | 0.5 | both surfaces of first layer | type of particle is |
| | | | | | | | | different |
| Sample 7 | Polyethylene | alumina | 0.47 | PVdF | 90.0 | 0.2 | both surfaces of first layer | surface density is |
| | | | | | | | | different (small) |
| Sample 8 | Polyethylene | alumina | 1.00 | PVdF | 90.0 | 0.6 | both surfaces of first layer | particle diameter is |
| | | | | | | | | different (alumina) |
| Sample 9 | Polyethylene | silica | 1.20 | PVdF | 95.0 | 0.2 | both surfaces of first layer | particle diameter is |
| | | | | | | | | different (silica) |
| Sample 10 | Polyethylene | alumina | 0.47 | PVdF | 90.0 | 0.2 | one surface of first layer | Coating surface is |
| Sample 11 | Polyethylene | alumina | 0.47 | PVdF | 90.0 | 0.6 | one surface of first layer | different (Ni piece |
| Sample 12 | Polyethylene | alumina | 0.47 | PVdF | 90.0 | 1.2 | one surface of first layer | is on the coating |
| | | | | | | | | surface side) |
| Sample 10 | Polyethylene | alumina | 0.47 | PVdF | 90.0 | 0.2 | one surface of first layer | Coating surface is |
| Sample 11 | Polyethylene | alumina | 0.47 | PVdF | 90.0 | 0.6 | one surface of first layer | different (Ni piece |
| Sample 12 | Polyethylene | alumina | 0.47 | PVdF | 90.0 | 1.2 | one surface of first layer | is on reverse side |
| | | | | | | | | of coating surface) |

TABLE 2

| | | | | Amount of heat | Cycle | Evaluation of | | |
|---|---|---|---|---|---|---|---|---|
| | Structure of | | Resistance in | generation in | maintenance | cycle | Transfer of | Amount of |
| | second layer | Location of Ni piece | short-circuit (Ω) | short-circuit (J) | factor (%) | characteristic | second layer | transfer |
| Sample 1 | network | aluminum foil side | 56 | 0.01 | 90 | ∘ | transfer | A |
| | structure | copper foil side | 47 | 0.01 | | ∘ | transfer | A |
| Sample 2 | network | aluminum foil side | 67 | 0.01 | 90 | ∘ | transfer | A |
| | structure | copper foil side | 45 | 0.01 | | ∘ | transfer | A |
| Sample 3 | network | aluminum foil side | 58 | 0.01 | 89 | ∘ | transfer | A |
| | structure | copper foil side | 9 | 0.02 | | ∘ | transfer | A |
| Sample 4 | network | aluminum foil side | 10 | 0.01 | 85 | ∘ | transfer | A |
| | structure | copper foil side | 6 | 0.02 | | ∘ | transfer | A |
| Sample 5 | network | aluminum foil side | no occurrence of | 0 | 85 | ∘ | transfer | A |
| | structure | | short-circuit | | | | | |
| | | copper foil side | no occurrence of | 0 | | ∘ | transfer | A |
| | | | short-circuit | | | | | |
| Sample 6 | network | aluminum foil side | 70 | 0.01 | 90 | ∘ | transfer | A |
| | structure | copper foil side | 65 | 0.01 | | ∘ | transfer | A |
| Sample 7 | network | aluminum foil side | 3 | 0.06 | 91 | ∘ | transfer | A |
| | structure | copper foil side | 5 | 0.03 | | ∘ | transfer | A |
| Sample 8 | network | aluminum foil side | 129 | 0.001 | 92 | ∘ | transfer | A |
| | structure | copper foil side | 69 | 0.01 | | | transfer | A |
| Sample 9 | network | aluminum foil side | 34 | 0.01 | 91 | ∘ | transfer | A |
| | structure | copper foil side | 65 | 0.01 | | ∘ | transfer | A |
| Sample 10 | network | coating surface side | 3 | 0.06 | 88 | ∘ | transfer | A |
| | structure | | | | | | | |
| Sample 11 | network | coating surface side | 45 | 0.01 | 86 | ∘ | transfer | A |
| | structure | | | | | | | |
| Sample 12 | network | coating surface side | no occurrence of | 0 | 83 | ∘ | transfer | A |
| | structure | | short-circuit | | | | | |
| Sample 10 | network | reverse side of coating | 0.09 | 69 | 91 | ∘ | no transfer | A |
| | structure | surface | | | | | | |
| Sample 11 | network | reverse side of coating | 0.09 | 69 | 90 | ∘ | no transfer | A |
| | structure | surface | | | | | | |
| Sample 12 | network | reverse side of coating | 0.09 | 69 | 92 | ∘ | no transfer | A |
| | structure | surface | | | | | | |

TABLE 3

| | | Second layer | | | | | | |
|---|---|---|---|---|---|---|---|---|
| | | | Average | | Volume | | | |
| | | | particle | | fraction of | Surface | | |
| | | | diameter | | particle | density | | |
| | First layer | Particle | d50(μm) | Resin | (vol %) | (mg/cm²) | Coating surface | Remarks |
| Sample 13 | Polyethylene | alumina | 0.47 | PVdF | 57.0 | 0.6 | both surfaces of first layer | volume fraction of |
| Sample 14 | Polyethylene | — | — | PVdF | 0.0 | 0.4 | both surfaces of first layer | particle is different |
| | | | | | | | | (small) |
| Sample 15 | Polyethylene | alumina | 0.47 | PVdF | 90.0 | 0.1 | both surfaces of first layer | surface density is |
| | | | | | | | | different (small: |
| | | | | | | | | alumina) |
| Sample 16 | Polyethylene | silica | 0.80 | PVdF | 95.0 | 0.1 | both surfaces of first layer | surface density is |
| | | | | | | | | different (small: |
| | | | | | | | | silica) |
| Sample 17 | Polyethylene | alumina | 2.00 | PVdF | 90.0 | 0.6 | formation of coating film is | particle diameter |
| | | | | | | | difficult (uniform coating | is different (large: |
| | | | | | | | film is not formed and | alumina) |
| | | | | | | | measurement is difficult) | |
| Sample 18 | Polyethylene | alumina | 0.013 | PVdF | 64.0 | 0.3 | both surfaces of first layer | particle diameter |
| | | | | | | | | is different (small: |
| | | | | | | | | alumina) |

PVdF: polyvinylidene fluoride

TABLE 4

| | | | | Amount of heat | Cycle | Evaluation of | | |
|---|---|---|---|---|---|---|---|---|
| | Structure of | Location of Ni | Resistance in | generation in | maintenance | cycle | Transfer of | Amount of |
| | second layer | piece | short-circuit (Ω) | short-circuit (J) | factor (%) | characteristic | second layer | transfer |
| Sample 13 | network | aluminum foil side | 0.09 | 69 | 88 | ∘ | no transfer | C |
| | structure | copper foil side | 0.09 | 69 | | ∘ | no transfer | C |
| Sample 14 | network | aluminum foil side | 0.09 | 69 | 50 | x | no transfer | C |
| | structure | copper foil side | 0.09 | 69 | | x | no transfer | C |
| Sample 15 | network | aluminum foil side | 0.09 | 69 | 89 | ∘ | no transfer | C |
| | structure | copper foil side | 0.09 | 69 | | ∘ | no transfer | C |
| Sample 16 | network | aluminum foil side | 0.09 | 69 | 90 | ∘ | no transfer | C |
| | structure | copper foil side | 0.09 | 69 | | ∘ | no transfer | C |
| Sample 17 | formation of coating film is difficult (uniform coating film is not formed and measurement is difficult) | | | | | | | |
| Sample 18 | network | aluminum foil side | 5 | 0.06 | 63 | x | transfer | C |
| | structure | copper foil side | 10 | 0.03 | | x | transfer | C |

network structure: three-dimensional mesh structure in which fibrils are mutually linked continuously

TABLE 5

| | | Second layer | | | | | | |
|---|---|---|---|---|---|---|---|---|
| | | | Average | | Volume | | | |
| | | | particle | | fraction of | Surface | | |
| | | | diameter | | particle | density | | |
| | First layer | Particle | d50(μm) | Resin | (vol %) | (mg/cm²) | Coating surface | Remarks |
| Sample 19 | Polyethylene | alumina | 0.10 | PVdF | 90.0 | 0.6 | both surfaces of first layer | particle diameter |
| | | | | | | | | lower limit |
| Sample 20 | Polyethylene | alumina | 1.50 | PVdF | 90.0 | 0.6 | both surfaces of first layer | particle diameter |
| | | | | | | | | upper limit |
| Sample 21 | Polyethylene | alumina | 0.05 | PVdF | 64.0 | 0.4 | both surfaces of first layer | the vicinity of |
| | | | | | | | | particle diameter |
| | | | | | | | | lower limit |
| Sample 22 | Polyethylene | alumina | 1.70 | PVdF | 90.0 | 0.6 | formation of coating film | the vicinity of |
| | | | | | | | is difficult (uniform coating | particle diameter |
| | | | | | | | film is not formed and | upper limit |
| | | | | | | | measurement is difficult) | |
| Sample 23 | Polyethylene | alumina | 0.47 | PVdF | 90.0 | 0.6 | both surfaces of first layer | separator not |
| | | | | | | | | having network |
| | | | | | | | | structure |
| Sample 24 | Polyethylene/ | — | 0.47 | — | 60.0 | — | drawing is difficult, and film | separator involving |
| | alumina | | | | | | is not formed | inorganic material |
| Sample 25 | Polyethylene | alumina | 0.10 | PVdF | 90.0 | 0.6 | both surfaces of first layer | separator having |
| | (fibril diameter | | | | | | | fibril diameter |
| | 1.1 μm) | | | | | | | exceeding 1 μm |

PVdF: polyvinylidene fluoride

TABLE 6

| | | | | Amount of heat | Cycle | Evaluation of | | |
|---|---|---|---|---|---|---|---|---|
| | Structure of | Location of Ni | Resistance in | generation in | maintenance | cycle | Transfer of | Amount of |
| | second layer | piece | short-circuit (Ω) | short-circuit (J) | factor (%) | characteristic | second layer | transfer |
| Sample 19 | network | aluminum foil side | 58 | 0.01 | 88 | ∘ | transfer | A |
| | structure | copper foil side | 99 | 0.01 | | ∘ | transfer | A |
| Sample 20 | network | aluminum foil side | 54 | 0.001 | 93 | ∘ | transfer | A |
| | structure | copper foil side | 103 | 0.01 | | ∘ | transfer | A |
| Sample 21 | network | aluminum foil side | 3 | 0.05 | 69 | x | transfer | B |
| | structure | copper foil side | 24 | 0.01 | | x | transfer | B |
| Sample 22 | formation of coating film is difficult (uniform coating film is not formed and measurement is difficult) | | | | | | | |
| Sample 23 | not having | aluminum foil side | 4 | 0.01 | 70 | x | transfer | B |
| | network | copper foil side | 15 | 0.01 | | x | transfer | B |
| | structure | | | | | | | |
| Sample 24 | drawing is difficult, and film is not formed (measurement is difficult) | | | | | | | |
| Sample 25 | network | aluminum foil side | 2 | 0.03 | 58 | x | transfer | B |
| | structure | copper foil side | 7 | 0.01 | | | transfer | B |

network structure: three-dimensional mesh structure in which fibrils are mutually linked continuously

TABLE 7

| | | Second layer | | | | | | |
|---|---|---|---|---|---|---|---|---|
| | | | Average | | Volume | | | |
| | | | particle | | fraction of | Surface | | |
| | | | diameter | | particle | density | | |
| | First layer | Particle | d50(μm) | Resin | (vol %) | (mg/cm²) | Coating surface | Remarks |
| Sample 26 | Polyethylene | alumina | 0.47 | PVdF | 60.0 | 0.5 | both surfaces of first layer | Volume fraction |
| | | | | | | | | lower limit |
| Sample 27 | Polyethylene | silica | 0.80 | PVdF | 97.0 | 0.6 | both surfaces of first layer | Volume fraction |
| | | | | | | | | upper limit |
| Sample 28 | Polyethylene | alumina | 0.47 | PVdF | 90.0 | 3.0 | both surfaces of first layer | Surface density |
| | | | | | | | | upper limit |
| Sample 29 | Polyethylene | alumina | 0.47 | PVdF | 90.0 | 3.2 | both surfaces of first layer | the vicinity of |
| | | | | | | | | surface density |
| | | | | | | | | upper limit |
| Sample 30 | Polyethylene | alumina | 0.47 | PVdF | 98.0 | 0.6 | formation of coating film is | the vicinity of |
| | | | | | | | difficult (uniform coating | volume fraction |
| | | | | | | | film is not formed and | upper limit |
| | | | | | | | measurement is difficult) | |

PVdF: polyvinylidene fluoride

TABLE 8

| | | | | Amount of heat | Cycle | Evaluation of | | |
|---|---|---|---|---|---|---|---|---|
| | Structure of | Location of Ni | Resistance in | generation in | maintenance | cycle | Transfer of | Amount of |
| | second layer | piece | short-circuit (Ω) | short-circuit (J) | factor (%) | characteristic | second layer | transfer |
| Sample 26 | network | aluminum foil side | 15 | 0.07 | 88 | ∘ | transfer | A |
| | structure | copper foil side | 5 | 0.02 | | ∘ | transfer | A |
| Sample 27 | network | aluminum foil side | 60 | 0.01 | 91 | ∘ | transfer | A |
| | structure | copper foil side | 55 | 0.01 | | ∘ | transfer | A |
| Sample 28 | network | aluminum foil side | no occurrence | 0 | 80 | ∘ | transfer | A |
| | structure | | of short-circuit | | | | | |
| | | copper foil side | no occurrence | 0 | | ∘ | transfer | A |
| | | | of short-circuit | | | | | |

| | | | | | | | |
|---|---|---|---|---|---|---|---|
| Sample 29 | network | aluminum foil side | no occurrence | 0 | insertion into can is difficult | transfer | A |
| | structure | | of short-circuit | | (evaluation of battery is difficult) | | |
| | | copper foil side | no occurrence | 0 | | transfer | A |
| | | | of short-circuit | | | | |

| | | | | | | |
|---|---|---|---|---|---|---|
| — | — | — | 75 | x | — | — |

| | |
|---|---|
| Sample 30 | formation of coating film is difficult (uniform coating film is not formed and measurement is difficult) |

network structure: three-dimensional mesh structure in which fibrils are mutually linked continuously

Test-Evaluation Result

The following facts are clear from Table 1 to Table 8 and FIG. 7 to FIG. 9.

In the case where separators are produced by manufacturing methods in Samples 1 to 16, 18 to 21, and 25 to 29, second layers having a three-dimensional network structure (mesh structure), in which fibrils are mutually linked continuously can be formed.

Samples 1 to 4: Samples having Different Volume Fractions

In the case where the volume fraction is 60.0 to 97.0 percent by volume, each Sample has a high resistance in short-circuit of 1Ω or more, and the cycle characteristic is good. Furthermore, regardless of whether the location of disposition of the nickel piece is on the aluminum foil side or on the copper foil side, the short-circuit resistance is high.

Sample 5: Sample having Large Surface Density

In the case where the surface density is 1.2 mg/cm², the short-circuit resistance is further improved and short-circuit does not occur. Moreover, the cycle characteristic is good. In addition, regardless of whether the location of disposition of the nickel piece is on the aluminum foil side or on the copper foil side, the short-circuit resistance is high.

Sample 6: Sample Including a Different Type of Particles (Silica Particles)

In the case where the type of inorganic particles is changed from alumina particles to silica particles, the resistance in short-circuit is a high 1Ω or more, and the cycle characteristic is good. Furthermore, regardless of whether the location of disposition of the nickel piece is on the aluminum foil side or on the copper foil side, the short-circuit resistance is high.

Sample 7: Sample having Small Surface Density

In the case where the surface density is 0.20 mg/cm², the resistance in short-circuit is a high 1Ω or more, and the cycle characteristic is good. Furthermore, regardless of whether the location of disposition of the nickel piece is on the aluminum foil side or on the copper foil side, the short-circuit resistance is high.

Sample 8: Sample having Different Average Particle Diameter (Alumina Particles)

In the case where the average particle diameter of alumina particles is changed to 1.0 μm, the resistance in short-circuit is a high 1Ω or more, and the cycle characteristic is good. Furthermore, regardless of whether the location of disposition of the nickel piece is on the aluminum foil side or on the copper foil side, the short-circuit resistance is high.

Sample 9: Sample having Different Average Particle Diameter (Silica Particles)

In the case where the average particle diameter of silica particles is changed to 1.2 μm, the resistance in short-circuit is a high 1Ω or more, and the cycle characteristic is good. Furthermore, regardless of whether the location of disposition of the nickel piece is on the aluminum foil side or on the copper foil side, the short-circuit resistance is high.

Samples 10 to 12: Samples Including Second Layer on Merely One Surface

In the case where the second layer is formed on merely one surface of the first layer, the second layer is disposed opposing to the aluminum foil side, and the test is conducted, when the nickel piece is disposed on the aluminum foil side, the resistance in short-circuit is a high 1Ω or more. The resistance in short-circuit increases as the surface density increases and when the surface density is 1.2 mg/cm², short-circuit does not occur. This is because when the separator is fractured, the second layer has been transferred to the contact surface of the nickel piece.

On the other hand, when the nickel piece is disposed on the copper foil side, the resistance in short-circuit is low and less than 1Ω. In the case where the nickel piece is disposed as described above, even when the surface density is increased, the value of the resistance in short-circuit is not changed and remains the same value less than 1Ω. This is because when the separator is fractured, the second layer has not been transferred to the contact surface of the nickel piece.

Samples 13 and 14: Samples having Small Volume Fractions

If the volume fraction is small, the resistance in short-circuit is low and becomes less than 1Ω. If the volume fraction is zero, the resistance in short-circuit is low and becomes less than 1Ω. In addition, the cycle characteristic is poor.

Sample 15: Sample having Small Surface Density (Alumina Particles)

If the surface density is small, sufficient insulating property is difficult to maintain, the resistance in short-circuit is low and becomes less than 1Ω. However, the cycle characteristic is good.

Sample 16: Sample having Small Surface Density (Silica Particles)

If the surface density is small, it is difficult to maintain sufficient insulating property, the resistance in short-circuit is low and becomes less than 1Ω. However, the cycle characteristic is good.

Sample 17: Sample having Large Average Particle Diameter (Alumina Particles)

In the case where the particle diameter was large, the coating film was stringy during coating, and it was difficult to obtain a uniform coating film. Consequently, it was difficult to conduct the short-circuit test and the cycle characteristic test. In this regard, it is believed that even if a film is formed by, for example, changing the material, when the particle diameter reaches about 2.00 μm the holding power of the binder is reduced and, thereby, transferability deteriorates.

Sample 18: Sample having Small Average Particle Diameter (Alumina Particles)

In the case where the average particle diameter of the alumina particles is a small 0.013 μm, the resistance in short-circuit is a high 1Ω or more, but the cycle characteristic deteriorates, so that the capacity maintenance factor after 200 cycles becomes less than 80%.

Sample 19: Sample having Small Average Particle Diameter (Alumina Particles)

In the case where the average particle diameter of the alumina particles is changed to 0.10 μm, the resistance in short-circuit is a high 1Ω or more and, in addition, the cycle characteristic is good. Furthermore, regardless of whether the location of disposition of the nickel piece is on the aluminum foil side or on the copper foil side, the short-circuit resistance is high.

Sample 20: Sample having Large Average Particle Diameter (Alumina Particles)

In the case where the average particle diameter of the alumina particles is changed to 1.50 μm, the resistance in short-circuit is a high 1Ω or more and, in addition, the cycle characteristic is good. Furthermore, regardless of whether the location of disposition of the nickel piece is on the aluminum foil side or on the copper foil side, the short-circuit resistance is high.

Sample 21: Sample having Average Particle Diameter Slightly Smaller than the Lower Limit (Alumina Particles)

In the case where the average particle diameter of the alumina particles is a small 0.05 μm, the resistance in short-circuit is a high 1Ω or more, but the separator tends to be clogged because the average particle diameter is small. Consequently, cycle characteristic deteriorates, and the capacity maintenance factor after 200 cycles becomes less than 80%.

Sample 22: Sample having Average Particle Diameter Slightly Larger than the Upper Limit (Alumina Particles)

In the case where the average particle diameter of the alumina particles was a large 1.70 μm, the coating film was stringy during coating, and it was difficult to obtain a uniform coating film. Consequently, the reliability of the coating film was not ensured and, therefore, it was difficult to conduct the short-circuit test and the cycle characteristic test. In this regard, it is believed that even if a film is formed by, for example, changing the material, when the particle diameter reaches about 1.70 μm, the holding power of the binder is reduced and, thereby, transferability deteriorates.

Sample 1: Sample having Network Structure (Mesh Structure)

The second layer is transferred to the nickel piece, and the amount of transfer thereof is sufficient. Therefore, a stable insulating function is performed.

Sample 23: Sample not having Network Structure (Mesh Structure)

The average particle diameter, the volume fraction, and the surface density are the same level as those of Sample 1. However, since the second layer does not have a network structure, the flexibility of the second layer is insufficient, and the second layer tends to not easily follow the nickel piece shape. Although the second layer is transferred to the nickel piece, transfer tends to become sparse. The resistance in short-circuit is high, but the transfer is insufficient. Consequently, the safety tends to be reduced.

Furthermore, the resistance in short-circuit is high, but a network structure is not employed, so that the ionic conductivity becomes poor, and the cycle characteristic deteriorates because of an increase in resistance. Consequently, the capacity maintenance factor after 200 cycles becomes less than 80%.

Sample 24: Sample in which Inorganic Particles are Incorporated into Base Material (Sample not having a Layer Structure)

Inorganic particles and a resin material can be kneaded, but the drawability is impaired significantly due to the inorganic particles, a film is not formed and, therefore, it was difficult to conduct evaluation.

Sample 25: Sample having Fibril Diameter Exceeding 1 μm

In the case where the solid concentration is high, the porosity is reduced, the ion permeability is hindered, and deterioration of cycle characteristic increases.

Furthermore, in a manner similar to those in Sample 23, the flexibility of the second layer is insufficient, and although the second layer is transferred to the nickel piece, transfer tends to become sparse. The resistance in short-circuit is high, but the transfer is insufficient. Consequently, the safety tends to be reduced.

Sample 26: Sample having Volume Fraction of Lower Limit Value

In the case where the volume fraction is 60.0 percent by volume, the resistance in short-circuit is a high 1Ω or more and, in addition, the cycle characteristic is good. Furthermore, regardless of whether the location of disposition of the nickel piece is on the aluminum foil side or on the copper foil side, the short-circuit resistance is high.

Sample 27: Sample having Volume Fraction of Upper Limit Value

Although the coating film strength was reduced because of an increase in inorganic particles, a uniform coating film was obtained. Furthermore, the resistance in short-circuit is a high 1Ω or more and, in addition, the cycle characteristic is good. Moreover, regardless of whether the location of disposition of the nickel piece is on the aluminum foil side or on the copper foil side, the short-circuit resistance is high.

Sample 28: Sample having Surface Density of Upper Limit Value

Although slight deterioration of the cycle characteristic is observed, the deterioration is at the level where no problem is caused, and short-circuit hardly occurs. Furthermore, regardless of whether the location of disposition of the nickel piece is on the aluminum foil side or on the copper foil side, the short-circuit resistance is high.

Sample 29: Sample having Surface Density Exceeding Upper Limit Value

The coating film was uniform, but the film thickness increased, so that it was difficult to insert the separator into a 18650 size circular cylinder cell.

The resistance in short-circuit was high, and short-circuit hardly occurred.

The electrode surface density of the separator of Sample 29 was reduced so that insertion into the can was conducted, and the battery characteristics were evaluated. Not only the capacity was reduced because of a reduction in the amount of active material, but also the cycle characteristic deteriorated.

Sample 30: Sample having Volume Fraction Exceeding Upper Limit Value

In the case where the volume fraction was 98.0 percent by volume, peeling of the coating film in phase separation was significant, so that it was difficult to obtain a uniform coating film.

Synthesis of Evaluation Results

The above-described evaluation results are synthesized. In order that the resistance in short-circuit is specified to be 1Ω or more, the amount of heat generation in short-circuit is specified to be 10 J or less, and the safety of the battery is improved, it is preferable that the volume fraction of the particles is specified to be 60 percent by volume or more, and 97 percent by volume or less. Furthermore, it is preferable that the surface density is specified to be 0.2 mg/cm² or more, and 3.0 mg/cm² or less. Moreover, it is preferable that the average particle diameter of the particles is specified to be within the range of 0.1 μm or more, and 1.5 μm or less. In addition, it is preferable to have a three-dimensional network structure, in which fibrils are mutually linked, where the average diameter of the fibrils is 1 μm or less.

Up to this point, the embodiments according to the present invention have been described specifically. However, the present invention is not limited to the above-described embodiments, and various modification on the basis of the technical idea of the present invention can be made.

For example, the configurations, the shapes, the materials, and the numerical values shown in the above-described embodiments are no more than examples, and as necessary, configurations, shapes, materials, numerical values, and the like different from them may be employed.

Furthermore, in the above-described embodiments, examples of application of the present invention to lithium ion batteries have been shown. However, the present invention is not limited by the type of the battery, but can be applied to any battery including a separator. For example, the present invention can also be applied to various types of batteries, e.g., nickel hydrogen batteries, nickel cadmium batteries, lithium-manganese dioxide batteries, and lithium-iron sulfide batteries.

Moreover, in the above-described embodiments, examples of application of the present invention to batteries having the rolled structure have been explained. However, the structure of the battery is not limited to this structure. The present invention can also be applied to, for example, a battery having a structure, in which a positive electrode and a negative electrode are folded, or a structure, in which they are stacked.

In addition, in the above-described embodiments, examples of application of the present invention to batteries of circular cylinder type or flat type have been explained. However, the shape of the battery is not limited to them. The present invention can also be applied to batteries of coin type, button type, rectangular type, or the like.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. A separator comprising:
a first layer having a first principal surface and a second principal surface; and
a second layer disposed on at least one of the first principal surface and the second principal surface,
wherein the first layer is a microporous film containing a polymer resin,
the second layer is a microporous film containing particles having an electrically insulating property and fibrils having an average diameter of 1 μm or less, and
the fibrils have a three-dimensional network structure in which the fibrils are mutually linked.

2. The separator according to claim 1, wherein the polymer resin is a polyolefin resin.

3. The separator according to claim 1,
wherein when sandwiched between copper foil and aluminum foil with a letter L shaped nickel piece of 0.2 mm high×0.1 mm wide with each side of 1 mm disposed between the copper foil or the aluminum foil, and the nickel piece is pressurized with 98 N,
the first layer is fractured at the portion corresponding to the nickel piece, and the second layer is transferred to a surface of the nickel piece.

4. The separator according to claim 1, wherein the volume fraction of particles in the second layer is 60 percent by volume or more, and 97 percent by volume or less.

5. The separator according to claim 1, wherein the mass per unit area of the second layer is 0.2 mg/cm2 or more, and 3.0 mg/cm2 or less.

6. The separator according to claim 1, wherein the average particle diameter of the particles is within the range of 0.1 μm or more, and 1.5 μm or less.

7. The separator according to claim 1, wherein the particle is a particle comprising an inorganic oxide as a primary component.

8. The separator according to claim 1, wherein the fibril comprises a fluororesin.

9. A separator,
wherein when sandwiched between copper foil and aluminum foil with a letter L shaped nickel piece of 0.2 mm high×0.1 mm wide with each side of 1 mm disposed between the copper foil or the aluminum foil, a voltage of 12 V in a constant-current condition of 25 A is applied between the copper foil and the aluminum foil, and the nickel piece is pressurized with 98 N,
a short-circuit resistance of 1Ω or more is obtained.

10. The separator according to claim 9, wherein the total amount of heat generation within 1 second from the time of occurrence of the short-circuit is 10 J or less.

11. A battery comprising:
a positive electrode;
a negative electrode;
an electrolyte; and
a separator,
wherein the separator includes
a first layer having a first principal surface and a second principal surface and
a second layer disposed on at least one of the first principal surface and the second principal surface,
the first layer is a microporous film containing a polymer resin,
the second layer is a microporous film containing particles having an electrically insulating property and fibrils having an average diameter of 1 μm or less, and
the fibrils have a three-dimensional network structure in which the fibrils are mutually linked.

12. The battery according to claim 11, wherein the open circuit voltage in a fully charged state is within the range of 4.2 V or more, and 4.6 V or less.

13. The battery according to claim 11,
wherein in the case where an inclusion is present between the positive electrode or the negative electrode and the separator, when the separator is fractured at the portion corresponding to the inclusion,
the second layer is transferred to a surface of the nickel piece.

14. A battery comprising:
a positive electrode;
a negative electrode;
an electrolyte; and
a separator,
wherein regarding the separator,
when sandwiched between copper foil and aluminum foil with a letter L shaped nickel piece of 0.2 mm high×0.1 mm wide with each side of 1 mm disposed between the copper foil or the aluminum foil, a voltage of 12 V in a constant-current condition of 25 A is applied between the copper foil and the aluminum foil, and the nickel piece is pressurized with 98 N,
a short-circuit resistance of 1Ω or more is obtained.
